(19) United States
(12) Patent Application Publication
(10) Pub. No.: US 2022/0293406 A1
(43) Pub. Date: Sep. 15, 2022

(54) APPARATUS AND METHODS FOR THERMAL DISSOCIATION IN A MASS SPECTROMETRY SYSTEM

(71) Applicant: DH Technologies Development PTE. LTD., Singapore (SG)

(72) Inventor: Yves LE BLANC, Newmarket (CA)

(21) Appl. No.: 17/636,745

(22) PCT Filed: Aug. 21, 2020
(86) PCT No.: PCT/IB2020/057870

§ 371 Date: Feb. 18, 2022

Related U.S. Application Data
(60) Provisional application No. 62/889,707, filed on Aug. 21, 2019.

(51) Int. Cl. H01J 49/00; H01J 49/16

(52) U.S. Cl. CPC H01J 49/0045; H01J 49/16

(57) ABSTRACT

Apparatus, systems and methods disclosed herein utilize an ion source region generally disposed between a sample introduction port and an ion guide of a mass spectrometry system to thermally fragment ions for transmission to and analysis by a downstream mass analyzer. In various aspects, the present disclosure provides methods of thermally fragmenting ions in an ion source region of a mass spectrometry system. Thermally fragmenting a plurality of ions can include increasing a temperature of the ions present in an ion source region. Thermally fragmenting a plurality of ions can include increasing the temperature of the ions in an ionization/fragmentation region associated with an ion source region defined by a substantially collision-free path. Implementations of the present disclosure are useful in mass spectrometry systems, including, for example, generating an enhanced fragmentation pattern.

### RELATED APPLICATION

This application claims priority to U.S. provisional application No. 62/889,707 filed on Aug. 21, 2019 the content of which is incorporated herein by reference in its entirety.

### THE FIELD

The present disclosure relates to mass spectrometry, and more particularly to apparatus and methods for thermally fragmenting ions of a sample in an ion source region within a mass spectrometry system.

### BACKGROUND

Mass spectrometry is an analytical technique for analyzing substances to determine their elemental and/or molecular composition and provide both quantitative and qualitative characterization. For example, mass spectrometry systems can be used to identify unknown compounds, to determine the isotopic composition of elements in a molecule, and to determine the structure of a particular compound by observing its pattern of fragmentation, as well as to quantify the amount of a particular compound in the sample.

High molecular weight samples, for example, biological tissue samples are typically digested and/or chemically separated prior to sample introduction to the mass spectrometry system. In mass spectrometry, these digested and/or chemically separated sample molecules are generally converted into ions using an ion source.

Ions can be generated at atmospheric pressure, for example, by electrospray ionization before they pass through an inlet orifice and enter an ion guide disposed in a vacuum chamber. In conventional mass spectrometry systems, a radio frequency (RF) signal applied to the ion guide provides collisional cooling and radial focusing along the central axis of the ion guide as the ions are transported into a subsequent, lower-pressure vacuum chamber in which one or more mass analyzers are disposed. Ions generated in mass spectrometry systems are channeled, focused, manipulated, and/or selected for detection and analysis by the mass analyzer(s).

### SUMMARY

The present disclosure provides mass spectrometry systems, apparatus and methods that employ thermally-induced dissociation of ions within a ionization/fragmentation region of the mass spectrometry system. In some embodiments, thermally-induced dissociation of ions can be useful to generate dissociated ions so as to facilitate mass spectrometric analysis of a plurality of different types of samples, including a variety of biological samples. In some embodiments, the present disclosure is particularly useful for thermally-induced dissociation of ions in a ionization/fragmentation region prior to one or more ion guides in a mass spectrometry system channeling the dissociated and/or fragmented ions downstream toward a mass analyzer for detection.

Mass spectrometers using known methods of fragmentation generally have shown a small probability of success with fragmenting high molecular weight species, such as biologics. Moreover, known methods of fragmenting sample ions early have also been shown to pose challenges with regard to downstream processing. The present disclosure recognizes that there is a need in mass spectrometry systems for enhanced methods to fragment ions, in particular high molecular weight species, for example, polypeptides such as antibodies, proteins, etc. prior to mass spectrometric analysis, and in particular, prior to their introduction into a first stage of the mass spectrometry system.

Teachings of the present disclosure provide for fragmentation of a variety of ionic species, and in particular, high molecular weight species into smaller subunits. In some embodiments, mass spectrometry systems, apparatus, and methods of the present disclosure are particularly useful for producing, transmitting, detecting, and analyzing small, structurally discernable subunits that are capable of providing enhanced structural information. In some embodiments, apparatus, systems, and methods of producing such discernable subunits can include thermally-induced dissociation of the ions that can fragment (i.e., break-up) sample ions into various component parts. By way of example, un-fragmented compounds such as peptides can have the same molecular weight but various different chemical formulas. For example, each of the various peptides VFAQHLK, VAFQHLK,; VFQHALK, and VHLAFQK exhibit the same molecular weight such that breaking up the peptide into one or more subunits (via thermally-induced fragmentation) can be useful to identify each of the peptide sequences accordingly.

In some embodiments, the thermally-induced dissociation of ions in accordance with various aspects of the present teachings can provide optimal fragmentation of a variety of ions, and particularly high molecular weight species, such as peptides (e.g., antibodies), prior to introducing the fragment ions into a first stage of mass analysis. As discussed in more detail below, in some embodiments, a differential ion mobility spectrometer can be disposed between the ion source and such a first stage of mass analysis, for example, in order to separate the ions based on their mobility through a drift gas.

Among other things, the present disclosure provides mass spectrometry systems, apparatus, and methods of fragmenting ions by increasing the temperature of ions to an elevated temperature, for example, a temperature greater than about 550° C., within an ion source or ion source region employed to generate those ions (e.g., an ionization chamber in fluid communication with an outlet end of electrospray ion source) and prior to their transmission to the first stage of mass analysis. In some embodiments, the elevated temperature can promote thermally-induced dissociation of at least a portion of ions generated in the ion source, for example, an electrospray ion source. The thermally fragmented ions can be transmitted to downstream components of the mass spectrometer, for example, one or more mass analyzers.

The methods and systems of the present teachings can be employed to fragment ionic species generated via ionization of a variety of different samples. Some examples of such samples can include, without limitation, small and large molecules, including biological molecules, such as polypeptides (e.g., proteins). By way of example, in some embodiments, the present methods and systems can be employed to fragment ions having a molecular weight of equal to or greater than about 40 kDa, for example, up to about 475 kDa.

In some embodiments, a sample can be reduced, for example, digested by enzymes, into smaller components prior to ionization and fragmentation. By way of example, a protein sample can be digested via one or more enzymes, such as trypsin, into smaller peptides prior to ionization and fragmentation. Further, in some embodiments, a sample can be subjected to a separation process, for example, liquid chromatography, prior to ionization and fragmentation.

A variety of ion sources can be employed in the methods and systems according to the present teachings. Some examples of suitable ion sources include, without limitation, an atmospheric pressure ion source; an atmospheric pressure chemical ion source; an electrospray ion source; a desorption ionization source; a beam ionization source; and a photoionization source.

A variety of mechanisms can be employed to raise the temperature of the ions within the ionization/fragmentation region. By way of example, the ions can be heated via a thermal energy source and/or can be exposed to radiation from a source of electromagnetic radiation. The thermal energy source can be positioned to emit and/or direct thermal energy to heat ions within the ionization/fragmentation region. In some embodiments, the thermal energy source can be substantially co-axially positioned such that the radiation from the thermal energy source can be substantially co-axially emitted and/or directed at or to the ions of the ion source. In some embodiments, the temperature of the ions can be increased to an elevated temperature of at least about 550° C., for example, in a range of about 550° C. to about 850° C.

In some embodiments, the ionization/fragmentation region can be associated with the ion source and the thermal energy source. By way of example, the ionization/fragmentation region can extend a distance of about 2-3 mm from an exit of the ion source, for example, the ionization/fragmentation region can extend a distance of about 2-3 mm from a nozzle of an electrospray ionization source. In some embodiments, the ionization/fragmentation region can extend a distance of up to about 7.5 mm from an exit of the ion source. For example, the ionization/fragmentation region can extend a distance of up to about 7.5 mm from a nozzle of an electrospray ionization source.

As noted above, in some embodiments, the elevated temperature can promote thermally-induced dissociation of at least a portion of the plurality of ions. In some embodiments, the thermally dissociated ions can exhibit a selectively enhanced fragmentation pattern. In some embodiments, the ions can exhibit an ion fragmentation efficiency of at least about 70%; at least about 75%; at least about 80%; at least about 85%; at least about 90%; or at least about 95%.

In some embodiments, the ionization of a sample can generate multiply charged ions, for example, z≥2, which can be more susceptible to fragmentation.

In some embodiments, the thermally dissociated ions can be transmitted to an inlet of a first stage of mass analysis in the mass spectrometry system. In some embodiments, the fragmented ions can be transmitted from the ion source to an inlet of a first stage of mass analysis of the mass spectrometer along a path such that at least some of the ions, and preferably the majority of the ions, for example, more than 50%, more than 60%, or more than 70% of the ions do not encounter a surface prior to reaching the inlet, thereby reducing and preferably eliminating diffusional losses of the ion fragments and/or formation of cation adducts. In some embodiments, the position of the ionization/fragmentation region and the inlet forms a substantially surface-free path.

In some embodiments, the thermally dissociated ions can undergo additional stages of dissociation within one or more downstream components of the mass spectrometer. By way of example, such additional dissociation stages can include electron capture dissociation (ECD), or collision-induced dissociation (CID).

In some embodiments, an ion source according to the present teachings can receive a sample from an upstream component, for example, a liquid chromatography column.

In some embodiments, a differential ion mobility spectrometry device is disposed downstream from the ion source such that the fragment ions generated by the ion source are first received by the differential ion mobility spectrometer (e.g., prior to being transmitted through one or more downstream mass analyzers).

The foregoing and other advantages, aspects, embodiments, features, and objects of the present disclosure will become more apparent and better understood by referring to the following detailed description when read in connection with the accompanying drawings.

### BRIEF DESCRIPTION OF THE DRAWINGS

A person of ordinary skill in the art will understand that the drawings, described below, are for illustration purposes only. The figures of the drawings are not intended to limit the scope of the applicant's teachings in any way. It is emphasized that, according to common practice, various features of the drawing are not to scale. On the contrary, the dimensions of the various features are or may be arbitrarily expanded or reduced for clarity. Included in the drawings are the following figures:

FIG. 1 is a flow chart depicting various steps in an embodiment of the present teachings for fragmenting ions in a mass spectrometry system,

FIG. 2, in a schematic diagram, illustrates a mass spectrometry system in accordance with one aspect of various embodiments of the present disclosure;

FIG. 3, in a schematic diagram, illustrates a mass spectrometry system having a differential mobility spectrometer prior to the first stage of mass analysis in accordance with one aspect of various embodiments of the present disclosure;

FIG. 4 depicts exemplary data showing the fragmentation pattern of GLEFSDPLK ions following thermal dissociation;

FIG. 5 depicts exemplary data showing the level of fragmentation of peptide ion GLEFSDPLK following increasing the ion temperature or increasing the voltage in the ion source region;

FIG. 6 depicts exemplary data showing the level of fragmentation of peptide ion TTDWVDLR following increasing the ion temperature or increasing the voltage in the ion source region;

FIG. 7 depicts exemplary data showing the level of fragmentation of peptide ion GLEFSDPLK following thermal dissociation using multiple ion sources;

FIG. 8 depicts exemplary data showing the level of fragmentation of peptide ion GLEFSDPLK following thermal dissociation using multiple ion sources;

FIGS. 9A-C depict exemplary data showing a fragmentation pattern of tryptic digested b-GAL peptide via LC/MS. FIG. 9A shows Liquid Chromatography-Mass Spectrometry analysis at an elevated temperature. FIGS. 9B-C show a % intensity for m/z ion below 1000 Da;

FIG. 10 depicts exemplary data showing the level of fragmentation of Tyr-Gly-Gly-Phe-Leu ion following thermal dissociation according to the charge of the sample;

FIG. 11, in a schematic diagram, illustrates the amino acid residues of the A-chain and B-chain of bovine insulin;

FIG. 12, in a schematic diagram, illustrates an ion source region of a mass spectrometry system in accordance with one aspect of various embodiments of the present disclosure;

FIG. 13 depicts exemplary data showing a fragmentation pattern of bovine insulin ions by increasing the ion temperature. FIG. 13 at panel (A) shows the fragmentation pattern of bovine insulin at 400° C. FIG. 13 at panel (B) shows the thermally-induced fragmentation pattern of bovine insulin at 700° C.;

FIG. 14 depicts exemplary data showing a fragmentation pattern of bovine insulin ions in combination with collision-induced dissociation;

FIG. 15 depicts exemplary data showing a fragmentation pattern of insulin analogs at 700° C. FIG. 15 at panel (A) shows thermally-induced dissociation of bovine insulin ions. FIG. 15 at panel (B) shows thermally-induced dissociation of novorapid ions. FIG. 15 at panel (C) shows thermally-induced dissociation of ARG-insulin ions;

FIG. 16 depicts exemplary data showing a fragmentation pattern of insulin analogs at 700° C., followed by collisionally-induced dissociation at 38 eV with CES=5 eV resulting in the formation of thermally dissociated ion having a general formula of (GERGFFYTxKx)⁺² ion. FIG. 16 at panel (A) shows thermally-induced dissociation of bovine insulin ions followed by collisionally-induced dissociation. FIG. 16 at panel (B) shows thermally-induced dissociation of novorapid ions followed by collisionally-induced dissociation. FIG. 16 at panel (C) shows thermally-induced dissociation of ARG-insulin ions followed by collisionally-induced dissociation;

FIGS. 17A-D depict exemplary data showing a fragmentation pattern of ubiquitin. Together, FIGS. 17A-B show the fragmentation pattern of ubiquitin at 375° C. and the thermally-induced dissociation fragmentation pattern of ubiquitin at 550° C. Together, FIGS. 17C-D show m/z ions from about 900 Da to about 970 Da including the appearance of new species via thermally-induced fragmentation and the disappearance of species because of the thermally-induced fragmentation process;

FIGS. 18A-D depict exemplary data showing a fragmentation pattern of ubiquitin. Together, FIGS. 18A-B show ion fragmentation pattern of ubiquitin in a range of 900 to 1000 Da acquired with the sample ions at an elevated temperature of about 375° C. and the thermally-induced dissociation of ubiquitin acquired with the sample ions at an elevated temperature of about at 550° C. Together, FIGS. 18C-D show ion fragmentation pattern of ubiquitin in a range above 2500 Da at an elevated temperature of about 375° C. and the thermally-induced dissociation of ubiquitin acquired with the sample ions at an elevated temperature of about 550° C.;

FIG. 19 depicts exemplary data showing a fragmentation pattern of an intact monoclonal antibody (mAb). FIG. 19 at panel (A) shows the fragmentation pattern of the mAb at 400° C. FIG. 19 at panel (B) shows the thermally-induced dissociation fragmentation pattern of mAb at 700° C.;

FIG. 20, in a schematic diagram, illustrates a general reaction of a monoclonal antibody with an enzyme, such that the mAb cleaves at the hinge to form two major species;

FIG. 21, in a schematic diagram, illustrates a general reaction of the two major species of mAb reduced via a chemical reduction;

FIG. 22 depicts exemplary data showing a fragmentation pattern scFc and F(ab′)₂. FIG. 22 at panel (A) shows a fragmentation pattern of the scFc at 200° C. FIG. 22 at panel (B) shows a fragmentation pattern of the F(ab′)₂ at 200° C. FIG. 22 at panel (C) shows a fragmentation pattern of the scFc at 550° C. FIG. 22 at panel (D) shows a fragmentation pattern of the F(ab′)₂ at 550° C.;

FIG. 23 depicts exemplary data showing fragmentation pattern scFc and F(ab′)₂. FIG. 23 at panel (A) shows a high mass range fragmentation pattern of the scFc at 200° C. FIG. 23 at panel (B) shows a high mass range fragmentation pattern of the F(ab′)₂ at 200° C. FIG. 23 at panel (C) shows a high mass range fragmentation pattern of the scFc at 550° C. FIG. 23 at panel (D) shows a high mass range fragmentation pattern of the F(ab′)₂ at 550° C.;

FIG. 24 depicts exemplary data showing a fragmentation pattern of GLEFSDPLK and DDTWVTLR ions following thermal dissociation in combination with differential mobility spectrometry using nitrogen as transport gas; and

FIG. 25 depicts exemplary data showing a fragmentation pattern of GLEFSDPLK and DDTWVTLR ions following thermal dissociation in combination with differential mobility spectrometry and having 1.5% ACN present in the transport gas.

### DEFINITIONS

Various terms relating to aspects of the present disclosure are used throughout the specification and claims. Such terms are to be given their ordinary meanings in the art, unless otherwise indicated. In order for the present disclosure to be more readily understood, certain terms are first defined below. Additional definitions for the following terms and other terms are set forth throughout the specification.

As used herein, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

As used herein, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps.

As used herein, the term “amino acid,” in its broadest sense, refers to any compound and/or substance that can be incorporated into a polypeptide chain, for example, through formation of one or more peptide bonds. In some embodiments, an amino acid has the general structure H2N—C(H)(R)—COOH. In some embodiments, an amino acid is a naturally-occurring amino acid. In some embodiments, an amino acid is a synthetic amino acid; in some embodiments, an amino acid is a D-amino acid; in some embodiments, an amino acid is an L-amino acid. “Standard amino acid” refers to any of the twenty standard L-amino acids commonly found in naturally occurring peptides. “Nonstandard amino acid” refers to any amino acid, other than the standard amino acids, regardless of whether it is prepared synthetically or obtained from a natural source. In some embodiments, an amino acid, including a carboxy- and/or amino-terminal amino acid in a polypeptide, can contain a structural modification as compared with the general structure herein. For example, in some embodiments, an amino acid may be modified by methylation, amidation, acetylation, and/or substitution as compared with the general structure. In some embodiments, such modification may, for example, alter the circulating half-life of a polypeptide containing the modified amino acid as compared with one containing an otherwise identical unmodified amino acid. In some embodiments, such modification does not significantly alter a relevant activity of a polypeptide containing the modified amino acid, as compared with one containing an otherwise identical unmodified amino acid. As will be clear from context, in some embodiments, the term “amino acid” is used to refer to a free amino acid; in some embodiments, it is used to refer to an amino acid residue of a polypeptide.

As used herein, the term “antibody” refers to an immunoglobulin molecule capable of specific binding to a target, such as a carbohydrate, polynucleotide, lipid, polypeptide, steroid, etc., through at least one antigen recognition site located in the variable domain of the immunoglobulin molecule. As used herein, the term encompasses not only intact polyclonal or monoclonal antibodies, but also, unless otherwise specified, any antigen-binding portion thereof that competes with the intact antibody for specific binding, fusion proteins comprising an antigen-binding portion, and any other modified configuration of the immunoglobulin molecule that comprises an antigen recognition site. Antigen-binding portions include, for example, Fab, Fab′, F(ab′)₂, Fd, Fv, domain antibodies (dAbs, for example, shark and camelid antibodies), portions including complementarity determining regions (CDRs), single chain variable fragment antibodies (scFv), maxibodies, minibodies, intrabodies, diabodies, triabodies, tetrabodies, v-NAR and bis-scFv, and polypeptides that contain at least a portion of an immunoglobulin that is sufficient to confer specific antigen binding to the polypeptide. Depending on the antibody amino acid sequence of the constant region of its heavy chains, immunoglobulins can be assigned to different classes. There are five major classes (i.e., isotypes) of immunoglobulins: IgA, IgD, IgE, IgG, and IgM, and several of these may be further divided into subclasses (subtypes), for example, IgG₁, IgG₂, IgG₃, IgG₄, IgA₁ and IgA₂. The heavy-chain constant regions that correspond to the different classes of immunoglobulins are called alpha, delta, epsilon, gamma, and mu, respectively. The subunit structures and three-dimensional configurations of different classes of immunoglobulins are well known.

As used herein, the term “antigen (Ag)” refers to the molecular entity used for immunization of an immunocompetent vertebrate to produce the antibody (Ab) that recognizes the Ag or to screen an expression library (e.g., phage, yeast or ribosome display library, among others). Herein, Ag is termed more broadly and is generally intended to include target molecules that are specifically recognized by the antibody or fragment thereof, thus including portions or mimics of the molecule used in an immunization process for raising the antibody or fragment thereof or in library screening for selecting the antibody or fragment thereof. Thus, for antibodies of the disclosure binding to IL-2, full-length IL-2 from mammalian species (e.g., human, monkey, mouse and rat IL-2), including monomers and multimers, such as dimers, trimers, etc. thereof, as well as truncated and other variants of IL-2, are referred to as an antigen.

As used herein, the term “high molecular weight” species refers to molecular species, for example, polypeptides such as an antibody. In some embodiments, such high molecular weight species are in solution. As found herein, these high molecular weight species can have molecular weights of at least about 40 kDa. In some embodiments, high molecular weight species can have an average molecular weight of at least about 25 kDa or more, including, for example, at least about 30 kDa, at least about 40 kDa, at least about 50 kDa, at least about 60 kDa, at least about 75 kDa, at least about 100 kDa, at least about 125 kDa, at least about 150 kDa, at least about 175 kDa, at least about 200 kDa, at least about 225 kDa, at least about 250 kDa, at least about 275 kDa, at least about 300 kDa, at least about 325 kDa, at least about 350 kDa, at least about 375 kDa, at least about 400 kDa, at least about 425 kDa, at least about 450 kDa, at least about 475 kDa or more.

As used herein, the term “polypeptide” refers to a polymer of at least three amino acids, linked to one another by peptide bonds. In some embodiments, the term is used to refer to specific functional classes of polypeptides. In such embodiments, the term “polypeptide” refers to any member of the class that shows significant sequence homology or identity with a relevant reference polypeptide. In many embodiments, such member also shares significant activity with the reference polypeptide. Alternatively or additionally, in many embodiments, such member also shares a particular characteristic sequence element with the reference polypeptide (and/or with other polypeptides within the class; in some embodiments, with all polypeptides within the class). For example, in some embodiments, a member polypeptide shows an overall degree of sequence homology or identity with a reference polypeptide that is at least about 30-40%, and is often greater than about 50%, 60%, 70%, 80%, 90%, 91%, 92%, 93%, 94%, 95%, 96%, 97%, 98%, 99% or more and/or includes at least one region (i.e., a conserved region that may in some embodiments, may be or comprise a characteristic sequence element) that shows very high sequence identity, often greater than 90% or even 95%, 96%, 97%, 98%, or 99%. Such a conserved region usually encompasses at least 3-4 and often up to 20 or more amino acids; in some embodiments, a conserved region encompasses at least one stretch of at least 2, 3, 4, 5, 6, 7, 8, 9, 10, 11, 12, 13, 14, 15 or more contiguous amino acids. In some embodiments, a useful polypeptide may comprise or consist of a fragment of a parent polypeptide. In some embodiments, a useful polypeptide may comprise or consist of a plurality of fragments, each of which is found in the same parent polypeptide in a different spatial arrangement relative to one another than is found in the polypeptide of interest (e.g., fragments that are directly linked in the parent may be spatially separated in the polypeptide of interest or vice versa, and/or fragments may be present in a different order in the polypeptide of interest than in the parent), so that the polypeptide of interest is a derivative of its parent polypeptide. In some embodiments, a polypeptide may comprise natural amino acids, non-natural amino acids, or both. In some embodiments, a polypeptide may comprise only natural amino acids or only non-natural amino acids. In some embodiments, a polypeptide may comprise D-amino acids, L-amino acids, or both. In some embodiments, a polypeptide may comprise only D-amino acids. In some embodiments, a polypeptide may comprise only L-amino acids. In some embodiments, a polypeptide may include one or more pendant groups, for example, modifying or attached to one or more amino acid side chains, and/or at the polypeptide's N-terminus, the polypeptide's C-terminus, or both. In some embodiments, a polypeptide may be cyclic. In some embodiments, a polypeptide is not cyclic. In some embodiments, a polypeptide is linear.

As used herein, the term “protein” refers to a polypeptide (i.e., a string of at least three amino acids linked to one another by peptide bonds). Proteins may include moieties other than amino acids (e.g., may be glycoproteins, proteoglycans, etc.) and/or may be otherwise processed or modified. Those of ordinary skill in the art will appreciate that a “protein” can be a complete polypeptide chain as produced by a cell (with or without a signal sequence), or can be a characteristic portion thereof. Those of ordinary skill will appreciate that a protein can sometimes include more than one polypeptide chain, for example linked by one or more disulfide bonds or associated by other means. Polypeptides may contain L-amino acids, D-amino acids, or both and may contain any of a variety of amino acid modifications or analogs known in the art. Useful modifications include, for example, terminal acetylation, amidation, methylation, etc. In some embodiments, proteins may comprise natural amino acids, non-natural amino acids, synthetic amino acids, and combinations thereof. The term “peptide” is generally used to refer to a polypeptide having a length of less than about 100 amino acids, less than about 50 amino acids, less than 20 amino acids, or less than 10 amino acids. In some embodiments, proteins are antibodies, antibody fragments, biologically active portions thereof, and/or characteristic portions thereof.

As used herein, the term “substantially” refers to a qualitative condition of exhibiting total or near-total extent or degree of a characteristic or property of interest. One of ordinary skill in the art will understand that electrical properties rarely, if ever, go to completion and/or proceed to completeness or achieve or avoid an absolute result. Substantially is therefore used herein to capture a potential lack of completeness inherent therein. Values may differ in a range of values within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than). For example, values may differ by 5%.

As used herein, the term “substantially free of”, when used to describe a material or compound, means that the material or compound lacks a significant or detectable amount of a designated substance. In some embodiments, the designated substance is present at a level not more than about 1%, 2%, 3%, 4% or 5% (w/w or v/v) of the material or compound. For example, a preparation of a particular stereoisomer is “substantially free of” other stereoisomers if it contains less than about 20%, 15%, 10%, 5%, 3%, 2%, 1%, 0.5% (w/w or v/v) of the other stereoisomers other than the particular stereoisomer designated.

As used herein, the term “substantially pure” means an object species is the predominant species present (i.e., on a molar basis it is more abundant than any other individual species in the composition), and in some embodiments, a substantially purified fraction is a composition wherein the object species (e.g., a glycoprotein, including an antibody or receptor) comprises at least about 50 percent (on a molar basis) of all macromolecular species present. Generally, a substantially pure composition will comprise more than about 80 percent of all macromolecular species present in the composition, in some embodiments, more than about 85%, 90%, 95%, and 99%. In some embodiments, the object species is purified to essential homogeneity (contaminant species cannot be detected in the composition by conventional detection methods) wherein the composition consists essentially of a single macromolecular species. In certain embodiments a substantially pure material is at least 50% pure (i.e., free from contaminants), in some embodiments, at least 90% pure, in some embodiments, at least 95% pure, yet in some embodiments, at least 98% pure, and in some embodiments, at least 99% pure. These amounts are not meant to be limiting, and increments between the recited percentages are specifically envisioned as part of the disclosure.

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

### DETAILED DESCRIPTION

Samples are generally introduced into mass spectrometry systems via gas or liquid introduction. A sample can be delivered to an ion source, which can ionize the sample to generate a plurality of ions, and the ions can then be channeled, focused, manipulated, and/or selected for detection downstream in the mass spectrometry system. Introduction of high molecular weight samples can cause complexity such that typically additional preparation with respect to the samples is necessary and/or additional equipment or steps are required for sample introduction, transmission, or analysis. In particular, high molecular weight samples, for example, proteins from biological fluid samples or tissue samples after an initial digestion are typically chemically separated, for example by liquid chromatography before ionization and introduction to the mass spectrometry system. Such separations can be complex, unreliable, and not necessarily reproducible.

In addition to or as an alternative to using separation techniques prior to introducing ions to the ion source as above described, mass spectrometry methods of analyzing high molecular weight samples can include performing fragmentation prior to entry of the ions into one or more ion guides. One known fragmentation process is collision-induced dissociation. In this technique, fragmentation of molecular ions is induced, for example, at the ion source and the ions are accelerated by some potential. The accelerated ions are directed or put on a path to collide with neutral molecules (e.g., argon, helium, or nitrogen), which collision results in an energy transfer and fragmentation of the molecular ion into smaller fragments. The smaller fragment ions can then be more easily processed for characterization, quantification, and analysis via mass spectrometry. The collision-induced dissociation approach has at least three distinct drawbacks. First, collision-induced dissociation is a non-selective fragmentation and will fragment all ion species that are generated by the ion source in an non-discriminatory way. Second, collision-induced dissociation typically does not work well on intact peptide and/or proteins of high molecular weight (>40 kDa). Third, collision-induced dissociation cannot be used to generate fragment ions prior to differential mobility or more particularly when using a differential ion mobility spectrometry device.

In addition to collision-induced dissociation, another fragmentation technique uses a heated capillary tube at the interface between the ion source and downstream components of the mass spectrometry system. Ions are formed upstream and transferred from the ionization region through the heated capillary tube downstream for mass analysis. (See for example, Rockwood et al. Thermally-induced Dissociation of Ions from Electrospray Mass Spectrometry, 5 Rapid Communications in Mass Spectrometry, 582-585 (1991); see also, Meot-Ner et al., Thermal Decomposition Kinetics of Protonated Peptides and Peptide Dimers, and Comparison with Surface-Induced Dissociation RCMS, 9 Rapid Communications in Mass Spectrometry, 829-836 (1995); see also Choi et al., Atmospheric Pressure Thermal Dissociation of Peptides and Proteins (58th ASMS, MP 071). In the above examples, fragmentation is performed in the heated capillary by raising the temperature of the capillary tube during transfer of the ions through the interface from the ion source region downstream. The capillary transfer tube heating approach, however, has at least two significant drawbacks. First, the observed fragmentation produced when ions are channeled through the heated capillary tube can be inefficient. The effect of this inefficiency is particularly pronounced for large molecular species such as polypeptides, which can result in a significant reduction in the number of ions. That is, rather than enhancing both the quantity and type of ion production, this capillary fragmentation approach can result in the opposite effect. Indeed, the poster presentation of Choi et al. in MP-071 noted above reported as much as 100× loss in signal. While not wishing to be bound to a particular theory, it is believed that the inefficiencies are a function of losses on the inner walls of the capillary tubes. A second drawback in the observed fragmentation of using a heated capillary tube may be extensive cation adduct formation, which can limit downstream options such as barring differential mobility spectrometry.

Among other things, the present disclosure recognizes that there is a need in mass spectrometry systems to fragment ions, in particular high molecular weight species, prior to downstream transmission of the ions to one or more downstream components, including mass analyzers, so as to take advantage of the smaller subunits at multiple stages of mass analysis. In some embodiments, the generation of lower molecular weight subunits according to the present teachings can permit enhanced mass discrimination, selection, quantification, and analysis.

In particular, the present disclosure encompasses a recognition that high molecular weight ions can pose various challenges to mass spectrometry systems, such that channeling, focusing, and/or manipulating of these ions can be inhibited, for example, because they are lost to the background, lost in the vacuum, and/or otherwise eliminated from analysis.

The present disclosure also encompasses a recognition that in mass spectrometry systems it is desirable to channel, focus, and/or manipulate ions in vacuum with high resolution and quantitative accuracy. In some embodiments, the present disclosure further encompasses a recognition that accurate molecular structure information from spectral data is particularly desirable, including peak separation, peak identification, and structure-indicated quantitation.

In some embodiments, apparatus, systems, and methods of the present disclosure can be useful for partial to full structural analysis, characterization, determination, and/or quantification of a sample. In some embodiments, apparatus, systems, and methods can be useful for detection of unique fragment ions. In some embodiments, implementations of the present disclosure are useful in mass spectrometry systems, including, for example, by improving the characterization and quantification of high molecular weight species. In some embodiments, implementation of the present disclosure can include any uses for structural identification and/or quantification of high-molecular-weight proteins that are particularly useful in life sciences, biopharmaceuticals, diagnostics, forensics, materials, natural products, pharmacokinetics, plant sciences, etc.

### Methods

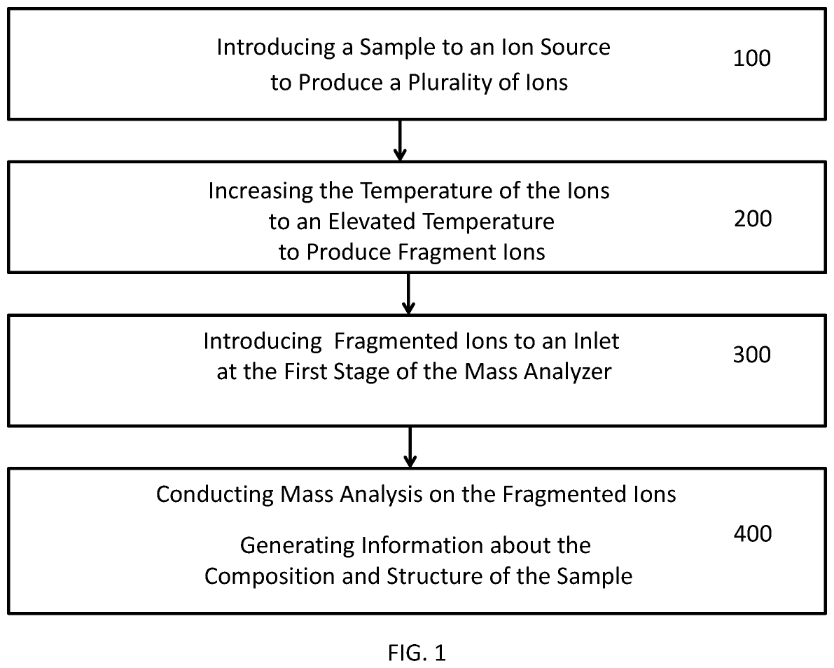

With reference to the flow chart of FIG. 1, in some embodiments, a method of fragmenting ions in a mass spectrometry system can include introducing a sample into an ion source so as to produce a plurality of ions (step 100), and increasing the temperature of the sample ions to an elevated temperature (e.g., at least about 550° C.) in order to cause thermal dissociation of at least a portion of the ions (step 200). Subsequently, the fragmented ions can be introduced from the ion source via an inlet into a first stage of mass analysis of the mass spectrometer (step 300). The fragment ions can then undergo mass analysis, for example, multiple stages of mass analyses, which can be used to generate information about the composition and structure of the sample from which the ions were obtained (step 400).

As noted above, the systems and methods according to the present teachings can be employed to analyze a variety of different samples, such as small and large molecules including polypeptides, for example, proteins, such as antibodies.

In some embodiments, the sample under analysis can have one or more target analytes exhibiting a high molecular weight, for example, at least about 40 kDa. By way of example, in some embodiments, the target analyte can have a molecular weight up to about 475 kDa. In some embodiments, the target analyte can have a molecular weight of about 40 kDa; about 50 kDa; about 60 kDa; about 70 kDa; about 80 kDa; about 90 kDa; about 100 kDa; about 110 kDa; about 120 kDa; about 130 kDa; about 140 kDa; about 150 kDa; about 160 kDa; about 170 kDa; about 180 kDa; about 190 kDa; about 200 kDa; about 210 kDa; about 220 kDa; about 230 kDa; about 240 kDa; about 250 kDa; about 260 kDa; about 270 kDa; about 280 kDa; about 290 kDa; about 300 kDa; about 310 kDa; about 320 kDa; about 330 kDa; about 340 kDa; about 350 kDa; about 360 kDa; about 370 kDa; about 380 kDa; about 390 kDa; about 400 kDa; about 410 kDa; about 420 kDa; about 430 kDa; about 440 kDa; about 450 kDa; about 460 kDa; about 470 kDa; about 475 kDa or more.

In some embodiments, a sample can be reduced into a plurality of smaller components, for example, via digestion by an enzyme, prior to ionization and fragmentation of the generated ions. For example, in some embodiments a polypeptide (e.g., a protein) can be exposed to an enzyme such as trypsin, which cleaves the C-terminus of an amino acid.

As noted above, a variety of ion sources can be employed in the practice of the present teachings. By way of example, some suitable ion sources which can be configured according to the present teachings to facilitate thermal dissociation of ions, can include, without limitation, chemical ionization source (e.g., an atmospheric pressure chemical ionization (APCI) source), a continuous ion source, an electron impact ion source, an electrospray ionization (ESI) source, a fast atom bombardment ion source, a glow discharge ion source, an inductively coupled plasma (ICP) ion source, a laser ionization device, a matrix-assisted laser desorption/ionization (MALDI) ion source, a nebulizer assisted atomization device, a nebulizer assisted electrospray device, a pulsed ion source, a photo-ionization ion source, a thermospray ionization device, or a sonic spray ionization device, among others.

As noted above, ions can be heated to an elevated temperature to cause the dissociation of at least a portion thereof in accordance with various aspects of the present teachings. A variety of mechanisms can be employed to raise the temperature of the ions within the ionization/fragmentation region by employing, without limitation, an infrared source, an electrical source, a laser source, a microwave source, a thermal energy source, among others. By way of example, the ions can be heated via a thermal energy source and/or can be exposed to radiation from a source of electromagnetic radiation. In some embodiments, the thermal energy source can be positioned to emit and/or direct thermal energy to heat ions within the ionization/fragmentation region. By way of example, the thermal energy source can be co-axially positioned such that the radiation can be co-axially emitted and/or directed at or to the ions of the ion source.

In some embodiments, the elevated temperature to which the ions are exposed to cause their fragmentation can be in a range of about 300° C. to about 1000° C. In some embodiments, the elevated temperature can be in a range of about 550° C. to about 850° C. In some embodiments, the elevated temperature can be about 300° C., about 325° C., about 350° C., about 375° C., about 400° C., about 425° C., about 450° C., about 475° C., about 500° C., about 525° C., about 550° C., about 575° C., about 600° C., about 625° C., about 650° C., about 675° C., about 700° C., about 725° C., about 750° C., about 775° C., about 800° C., about 825° C., about 850° C., about 875° C., about 900° C., about 825° C., about 950° C., about 975° C., or about 1000° C.

In some embodiments, the step of increasing the temperature of the ions occurs within an ionization/fragmentation region concurrent with or immediately after ion formation. An ionization/fragmentation region, as used herein, refers to a region in which ions associated with a sample can be formed using an ion source and further the region in which thermally dissociated ions associated with a sample can be formed using a thermal energy source. In some embodiments, the ionization/fragmentation region can be associated with the ion source and the thermal energy source. For example, in some embodiments, the ionization/fragmentation region can extend a distance of up to about 7.5 mm from an exit of the ion source. In some aspects, the ionization/fragmentation region can extend a distance of about 2-3 mm from an exit of the ion source.

In some embodiments, the ionization/fragmentation region can extend about 0.1 mm to about 7.5 mm beyond the exit of the ion source. For example, the ionization/fragmentation region can extend a distance of about 7.5 mm from a nozzle of an electrospray ionization source. In some embodiments, the ionization/fragmentation region can extend beyond the exit of the ion source by a distance of about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, 2.1 mm, about 2.2 mm, about 2.3 mm, about 2.4 mm, about 2.5 mm, about 2.6 mm, about 2.7 mm, about 2.8 mm, about 2.9 mm, about 3.0 mm, 3.1 mm, about 3.2 mm, about 3.3 mm, about 3.4 mm, about 3.5 mm, about 3.6 mm, about 3.7 mm, about 3.8 mm, about 3.9 mm, about 4.0 mm, 4.1 mm, about 4.2 mm, about 4.3 mm, about 4.4 mm, about 4.5 mm, about 4.6 mm, about 4.7 mm, about 4.8 mm, about 4.9 mm, about 5.0 mm, 5.1 mm, about 5.2 mm, about 5.3 mm, about 5.4 mm, about 5.5 mm, about 5.6 mm, about 5.7 mm, about 5.8 mm, about 5.9 mm, about 6.0 mm, 6.1 mm, about 6.2 mm, about 6.3 mm, about 6.4 mm, about 6.5 mm, about 6.6 mm, about 6.7 mm, about 6.8 mm, about 6.9 mm, about 7.0 mm, 7.1 mm, about 7.2 mm, about 7.3 mm, about 7.4 mm, about 7.5 mm, or more.

In some embodiments, the temperature of the ions is increased prior to ions reaching an inlet of a first stage of a mass analysis in a mass spectrometer such that the majority of the fragment ions generated due to the elevated temperature, and preferably all of the fragment ions, reach the inlet without undergoing collisions with any surface, which would result in their diffusional loss. In this manner, the present methods and systems can generate ion fragments efficiently and deliver them to a first stage of mass analysis with minimal, and in many cases with no, diffusional loss. In some embodiments, the fragmented ions can additionally be subject to ion mobility spectrometry (e.g., via a differential mobility spectrometer) prior to entering the first stage of mass analysis.

In some embodiments, the present disclosure provides an ability to perform efficient fragmentation of biologics and biologically related analytes. For example, the methods and systems according to the present teachings can be employed to perform efficient fragmentation of species ranging from tryptic peptides to intact proteins. The fragment ions can then be subjected to mass analysis, for example, multiple tandem mass analysis. For example, in some embodiments, the ions can be first be subjected to differential mobility spectrometry followed by subsequent mass analysis performed by one or more mass analyzers.

While not wishing to be bound to any particular theory, increasing the temperature of the ions within an ion source region to an elevated temperature promotes thermally-induced dissociation of at least a portion of the ions In some embodiments, under these conditions, the ionization of a sample can result in the formation of multiply charged ions, which can exhibit a heightened susceptibility to such fragmentation. In some such embodiments, for example, singly charged ions and neutrals can be essentially unaffected.

### Mass Spectrometry Systems

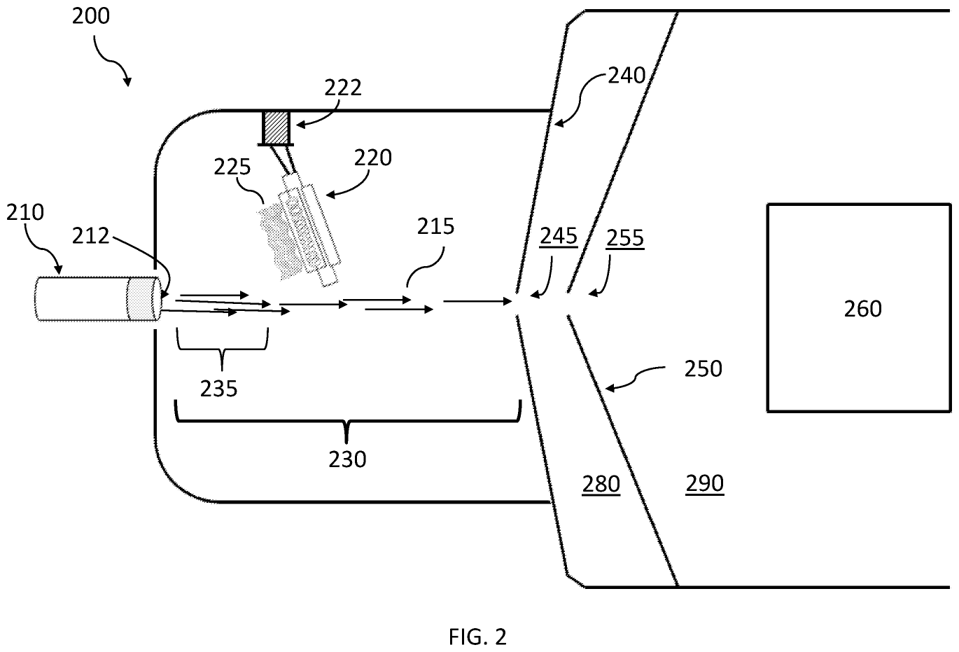

With reference to FIG. 2, a mass spectrometry system 200 according to an embodiment of the present teachings includes an electrospray ion source 210, which can ionize at least a portion of a received sample so as to generate a plurality of ions. More specifically, in this embodiment, the sample undergoes ionization within an ionization/fragmentation region 235.

In particular, in this embodiment, a thermal energy source 220, for example, a heated filament attached to a mount 222 is shown substantially co-axially emitting radiation to the ionization/fragmentation region 235. The thermal energy source 220 generates heat 225 for actively heating the ions generated within the ionization/fragmentation region 235. The distance of the ionization/fragmentation region can be about 5 mm, more preferably about 2 to 3 mm, from the outlet end 212 or exit of the electrospray ion source 210. The heating of the ions raises their temperature to an elevated temperature, for example, in a range of about 300° C. to about 1000° C., which can in turn cause thermal dissociation of at least a portion of the ions. The ions and/or thermally dissociated fragments are transmitted from the ionization/fragmentation region 235 downstream to a curtain plate aperture inlet 245 of the mass spectrometry system 200 and therethrough to a downstream mass analyzer 260. The majority of the ions and the fragments, and in many cases all of the ions and fragments, are transmitted from the ionization/fragmentation region 235 to the inlet 245 along a path 230 without undergoing collisions with surrounding walls. Thus, the ions and the fragments are delivered to the inlet 245 with minimal, and in many cases with no, diffusional loss. The mass analyzer 260 can detect and/or process ions generated by the electrospray source 210.

In some embodiments, as will be appreciated by a person of ordinary skill in the art in light of the present teachings, the outlet end 212 of the electrospray electrode 210 can atomize, aerosolize, nebulize, or otherwise discharge, for example, spray with a nozzle a sample into the ionization/fragmentation region 235 to form a sample plume 215. In some embodiments, the sample plume 215 includes micro-droplets that can be generally directed toward curtain plate aperture inlet 245 and the vacuum chamber sampling orifice 255. In some embodiments, a plurality of micro-droplets of the sample can be ionized. In some embodiments, ionization of the sample can form singly and/or multiply charged species by the electrospray source 210. As discussed above, the heat generated by the thermal energy source 220 can raise the temperature of the ions to an elevated temperature, which can cause thermal dissociation of at least a portion of the ions.

In some embodiments, the ionization/fragmentation region 235 can be evacuated to a pressure lower than atmospheric pressure while in some other embodiments, the ionization/fragmentation region 235 can be maintained at atmospheric pressure. As shown, the mass spectrometer system 200 includes a curtain plate 240, which is separated from a downstream plate 250 by a gas chamber 280. A flow of a gas (e.g., a noble gas) through the gas chamber 280 can diminish, and preferably prevent, the passage of neutral species to downstream components of the mass spectrometer. As noted above, in this embodiment, the ionization/fragmentation region 235 is in communication with downstream components of the mass spectrometer via the inlet apertures 245 and 255. In this embodiment, a vacuum chamber 290 houses the mass analyzer 260. The vacuum chamber 290 can be maintained at one or more selected pressure(s), for example, at a sub-atmospheric pressure in a range of about 5 Torr to about 8 mTorr

The mass analyzer 260 can assume one of a variety of configurations. In some embodiments, the mass analyzer 260 can be configured to process (e.g., filter, sort, dissociate, detect, etc.) sample ions generated by the electrospray source 210. In some embodiments, by way of non-limiting example, the mass analyzer 260 can be a triple quadrupole mass spectrometer. In some embodiments, the mass analyzer 260 can be any mass analyzer known in the art or modified in accordance with the teachings herein. It will further be appreciated that any number of additional elements can be included in the mass spectrometer system 200 including, for example, an ion mobility spectrometer (e.g., a differential mobility spectrometer) that is configured to separate ions based on their mobility through a drift gas rather than their mass-to-charge ratio. Additionally, it will be appreciated that the mass analyzer 260 can include a detector that can detect ions which pass through the mass analyzer 260 and can, for example, supply a signal indicative of the number of ions per second that are detected.

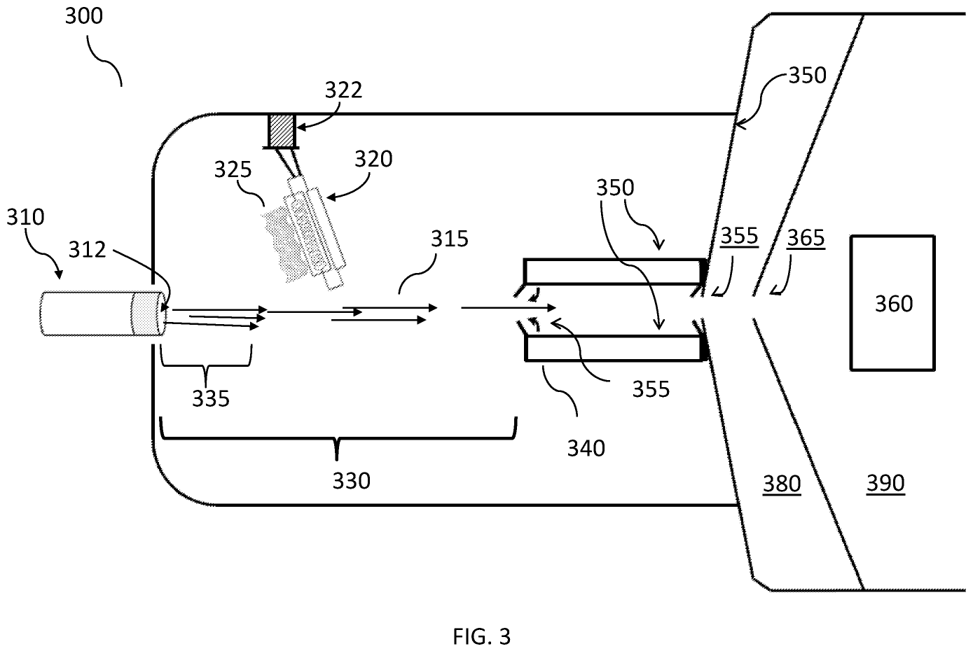

With reference to FIG. 3, a mass spectrometry system 300 according to an embodiment includes an electrospray ion source 310, the ions and/or ion fragments generated by an ion source 310 according to the present teachings are received by a downstream differential mobility mass spectrometer 340 prior to the first stage of mass analysis. As is known in the art, a differential mobility mass spectrometer separates ions that are present in the gas phase based on differences in their chemical structure. After ionization by the electrospray ion source 310, and thermally-induced fragmentation by the heater 320, the thermally dissociated ions enter a differential mobility mass spectrometer 340. The fragmented ions are carried by a carrier gas (N₂) 355 between two planar electrodes 355 to which a high-voltage radio frequency asymmetric waveform can be applied. The high-voltage radio frequency asymmetric waveform operates as a separation voltage, which causes ions to oscillate toward one electrode or the other depending upon the difference in the ion's mobility during high-field and low-field portions of the waveform. To ensure that an ion is detected by the MS, a direct current voltage, that is, a compensation voltage (CoV) deflects ions away from collisions with the electrodes and toward the MS. While not wishing to be bound to any particular theory, it is believed that differential mobility spectrometry can reduce a need to use LC-MS and can still provide reduced isobaric and isomeric chemical noise levels. In this embodiment, another mass analyzer 360, for example, including one or more quadrupole mass analyzers, are positioned downstream of the differential mobility mass spectrometer 340 to provide additional stages of mass analysis.

### Ion Sources

A variety of ion generation techniques can be employed in the practice of the present teachings. Some non-limiting examples of such ion generation techniques include, without limitation, chemical ionization, atmospheric pressure chemical ionization (APCI) electron impact ionization, electrospray ionization, glow discharge ionization, an inductively coupled plasma (ICP) ionization, laser ionization, matrix-assisted laser desorption/ionization (MALDI), photo-ionization, thermospray ionization, among others.

### Heating Sources

As noted above, in some embodiments, the heating of the ions can be achieved by various heat-generating sources. Some non-limiting examples of such heat-generating sources can include electromagnetic radiation sources providing radiation with wavelengths to generate heating of the spray region. Additionally or alternatively, other examples of suitable electromagnetic sources that may be used include infrared or microwave radiation sources, laser sources, thermal sources (e.g., heated filaments), among others.

In some embodiments, when ions, for example, electrospray generated ions are exposed to elevated temperature in a dry environment, they can absorb sufficient thermal energy to decompose, dissociate, and/or fragment. In some embodiments, under these conditions, multiply charged ions (z²) can exhibit a heighted susceptibility to such fragmentation, while singly charged ions and neutrals can be essentially unaffected.

In some embodiments, the heat-generating sources can be mounted substantially co-axially with a path of the ions. By way of example, a co-axial diversion, as used herein, refers to an amount that deviates by less than 10° from a perfectly axial direction.

### Ion Source Geometry

As discussed above, in some embodiments, an ionization/fragmentation region in which the generated ions are subjected to heating can be in communication with an inlet of a first stage of a mass analysis in the mass spectrometer such that the path along which the majority of the ions, and preferably all of the ions, traverse to reach the inlet does not involve striking a surface that would cause diffusional loss of the ions and/or their fragments.

Furthermore, also as noted above, cation adducts can form on and/or in vicinity of surfaces as ions approach those surfaces. By ensuring that the ion path from the ionization path to the inlet stays clear of such surfaces, the formation of cation adducts can be reduced, and preferably eliminated. In some embodiments, the position of the ionization/fragmentation region and the inlet forms a substantially surface-free path.

As noted above, in some embodiments, mass spectrometry systems, apparatus, and methods as disclosed herein can be used in conjunction with other fragmentation techniques, such as collisionally-induced dissociation (for conventional quantitation or sequence confirmation) or middle down sequencing where electron-capture dissociation relies on relatively smaller subunits (e.g., less than 50 kDa) to yield high sequence coverage.

In some embodiments, methods and systems according to the present teachings can cause thermal dissociation of ions at a fragmentation efficiency of at least about 70%, for example, a fragmentation efficiency of at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%, or at least about 91%, or at least about 92%, or at least about 93%, or at least about 94%, or at least about 95%, or at least about 96%, or at least about 97%, or at least about 98%, or at least about 99%, or about 100%.

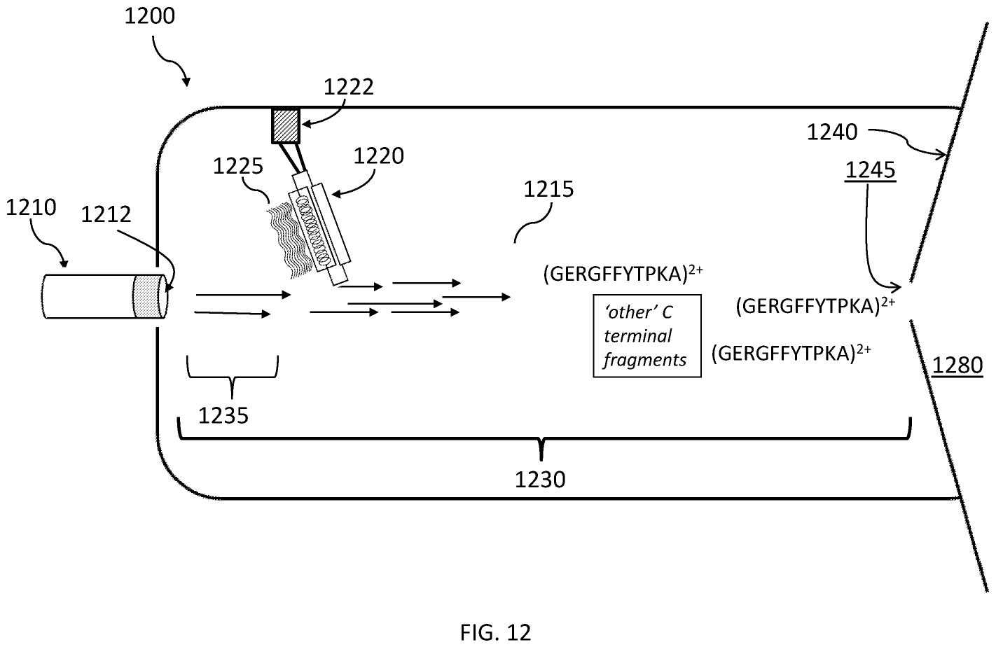

FIG. 12 shows an exemplary electrospray/thermal source 1200 in accordance with various aspects of the present teachings. In this embodiment, sample ions 1215 are transmitted from the electrospray source 1210 to a downstream region 1280 through the ionization/fragmentation region 1235 and a curtain plate 1240.

A thermal energy source 1220 is shown in FIG. 12 as mounted in the ionization/fragmentation region 1235. The sample ions are actively heated via heat 1225 generated by the thermal energy source to an elevated temperature in the ionization/fragmentation region 1235 such that at least a portion of the ions undergo a thermally-induced dissociation within the ionization/fragmentation region 1235. The thermally dissociated ions travel along a path 1230 between the ionization/fragmentation region 1210 and an inlet 1245. In this example, the sample included bovine insulin, which can be ionized and fragmented to generate doubly-charged C-terminal fragments (GERGFFYTPKA)²⁺.

### EXEMPLIFICATION

The following examples illustrate some embodiments and aspects of the present disclosure. It will be apparent to those skilled in the relevant art that various modifications, additions, substitutions, and the like can be performed without altering the spirit or scope of the disclosure, and such modifications and variations are encompassed within the scope of the disclosure as defined in the claims, which follow. The present disclosure will be more fully understood by reference to these examples. The following examples do not in any way limit the present disclosure or the claims and they should not be construed as limiting the scope.

### Example 1

The present example discloses data showing a fragmentation pattern following thermally-induced dissociation of a peptide GLEFSDPLK in accordance with various aspects of the present teachings.

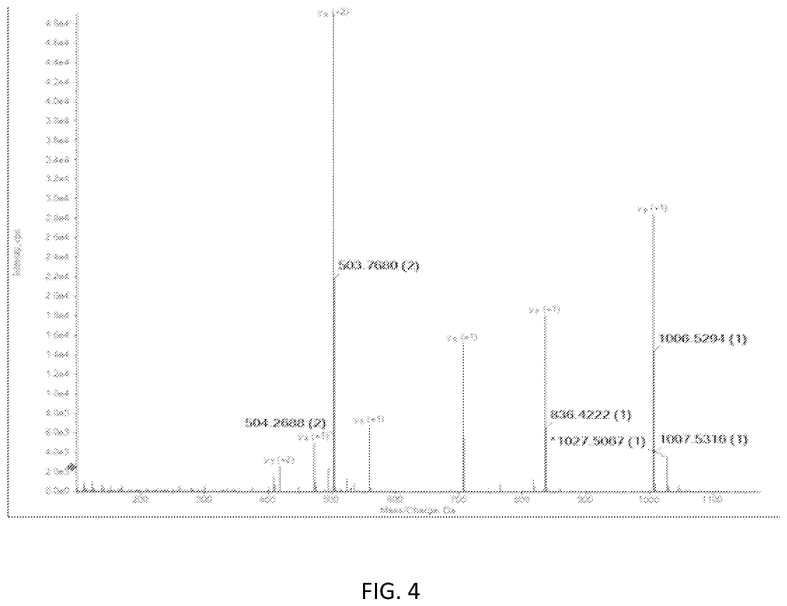

In particular, in this example, the sample peptide GLEFSDPLK was ionized using electrospray ionization and the temperature of the ionized sample was then elevated in the ion source ionization/fragmentation region to a temperature of about 550° C. to cause thermal dissociation of at least a portion of the generated ions. FIG. 4, which shows the resultant fragmentation pattern under these conditions, indicates that predominantly y-fragment ions of the sample peptide were generated by the thermally-induced dissociation.

### Example 2

The present example discloses various conditions of dissociation and/or fragmentation of a peptide.

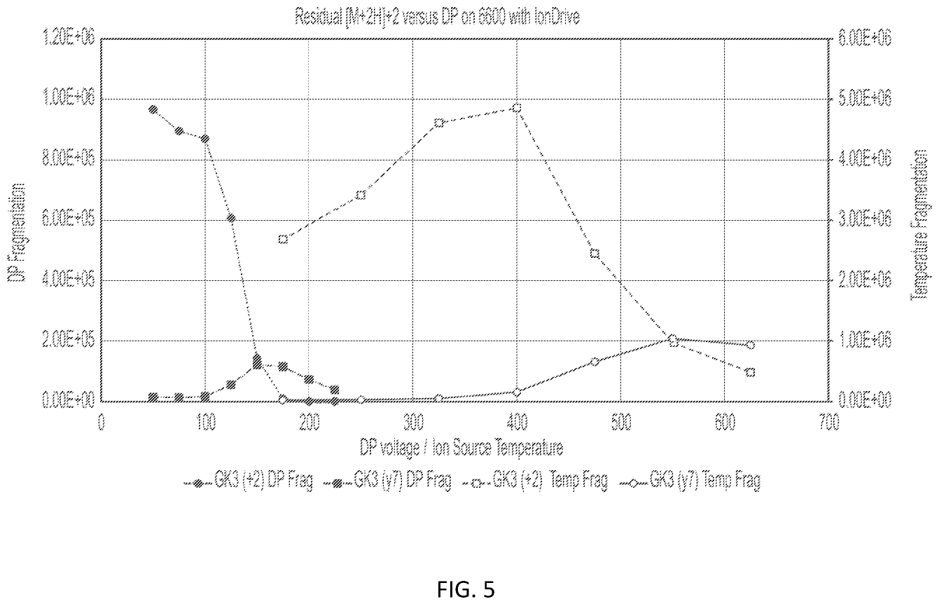

With reference to FIG. 4, in this example, samples of a peptide GLEFSDPLK were ionized using electrospray ionization and fragmented using two different methods of fragmentation: a voltage induced fragmentation (DP Frag) and a thermally-induced fragmentation (Temp Frag). FIG. 5 shows the level of fragmentation as a function of declustering potential (DP) as well as the temperature of the ions. It is noted that a similar level of fragmentation can be observed for both methods of fragmentation.

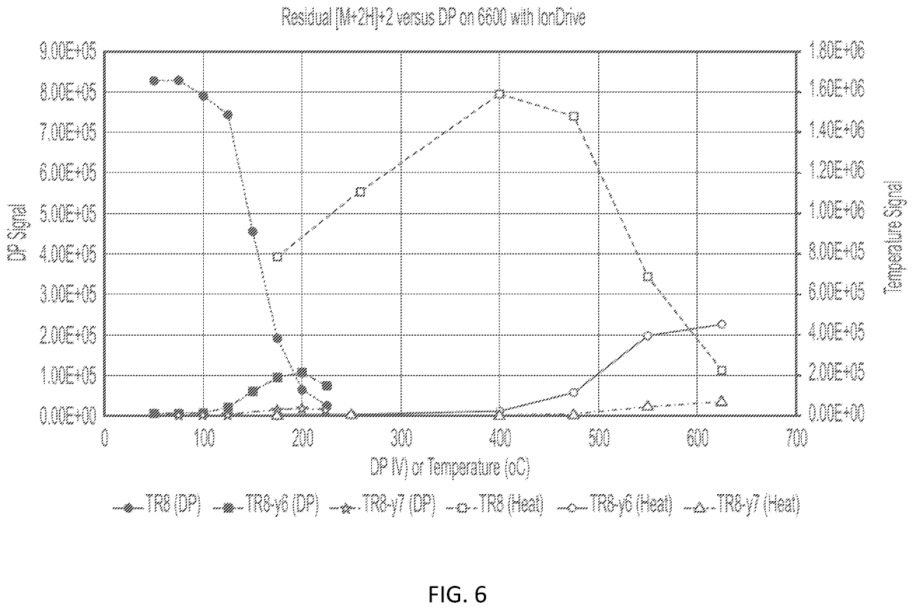

With reference to FIG. 5, in this example, samples of a peptide TTDWVDLR were ionized using electrospray ionization and fragmented using two different methods of fragmentation, a voltage induced fragmentation (DP Frag) and a thermally-induced fragmentation (Temp Frag). FIG. 6 shows the level of fragmentation for two different fragments (y6 and y7) as a function of declustering potential (DP) as well as the temperature of the ions. It is again noted that a similar level of fragmentation can be observed for both methods of fragmentation.

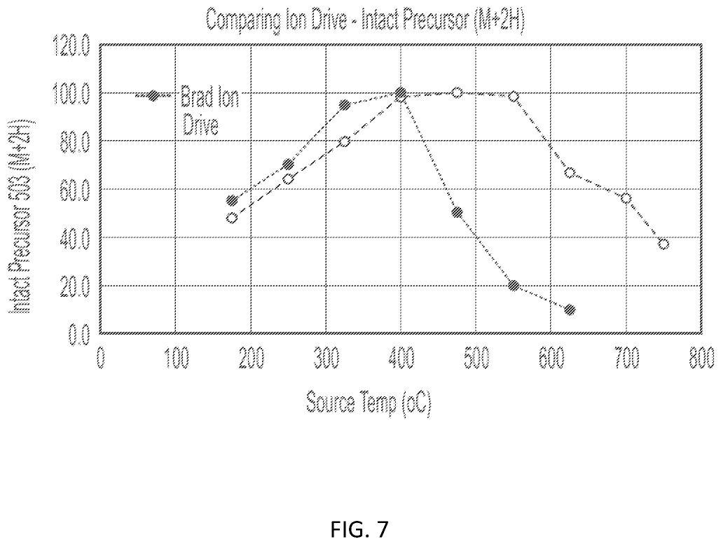

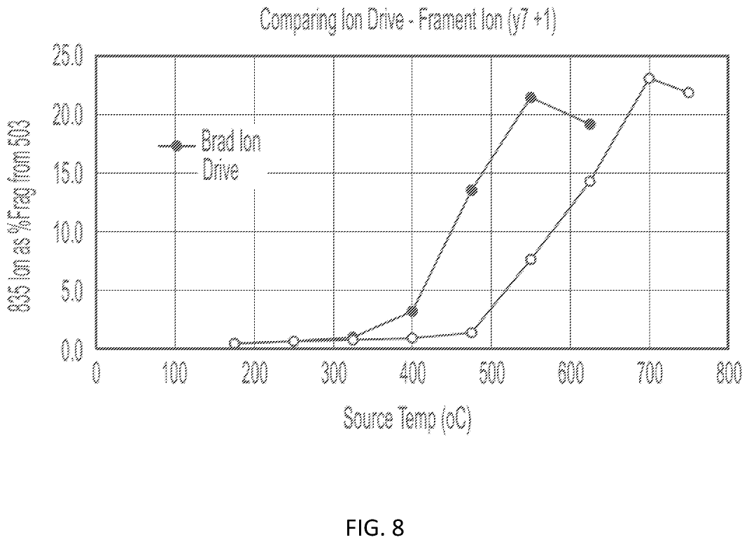

Moreover, with reference to FIGS. 7 and 8, samples of a peptide GLEFSDPLK were ionized using electrospray ionization and fragmented using a thermally-induced fragmentation. The peptide samples of the present example were ionized in multiple different sample runs that utilized two different ion source geometries. FIG. 7 shows that the two ion sources were assessed for fragmentation efficiency/reproducibility for an intact precursor (M+2H). FIG. 7 shows that a similar level of fragmentation was observed with regard to the level of intact precursor ion with increasing temperature from the different source geometries. FIG. 8 shows two ion sources were assessed for fragmentation efficiency/reproducibility for fragment ion (y₇¹⁺). FIG. 8 also shows that a similar level of fragmentation was observed with regard to the level of fragment ions with increasing temperature from the different source geometries.

### Example 3

The present example discloses thermally-induced dissociation of a tryptic digested b-GAL peptide via LC-MS.

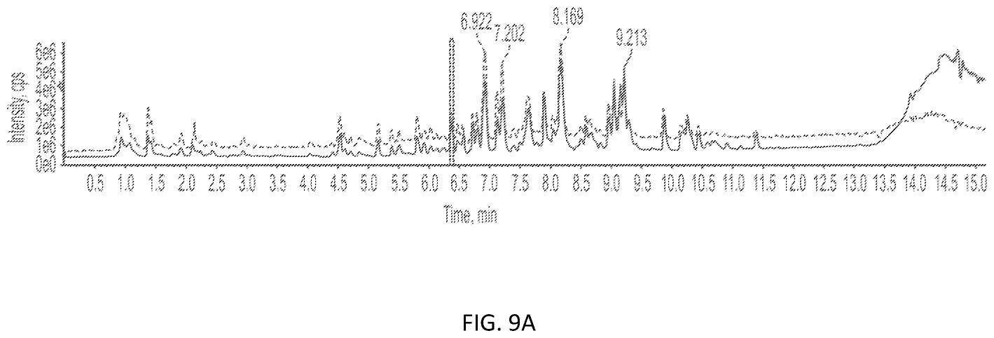

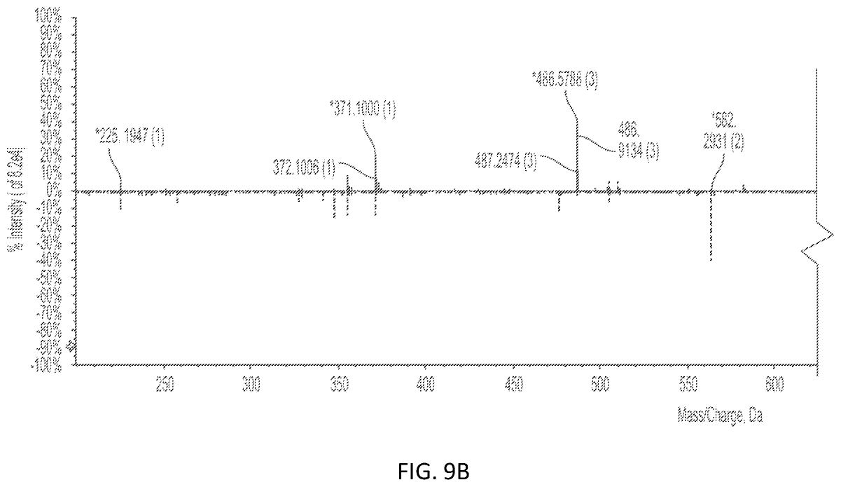

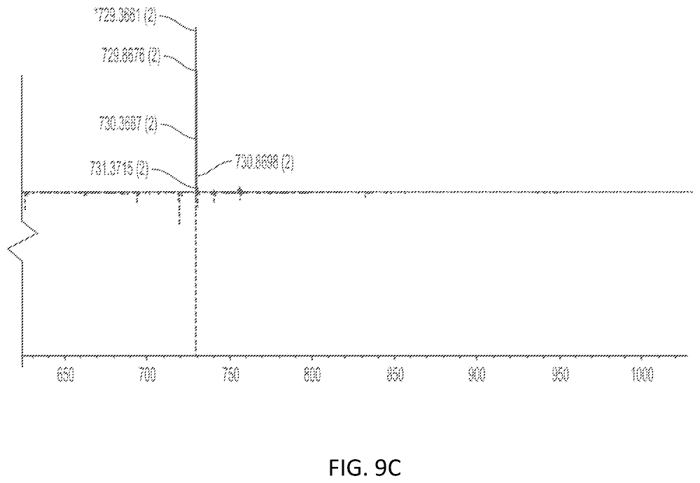

Prior to ionization and thermally-induced dissociation, samples of a b-GAL peptide were exposed to trypsin. The tryptic digested b-GAL peptide were then sampled via LC-MS. The present example at FIGS. 9A-C shows the fragmentation patterns observed after the samples were ionized via electrospray ionization and fragmented via increased temperature of an ionized sample. In this example, multiple ionized samples were run. The ionized samples were elevated to two temperatures, 300° C. and 600° C. FIG. 9A shows LC analysis at the elevated temperatures. The LC analysis shows the ability of utilizing increasing temperature to perform mass selection, that is, a pseudo-MS³ selection, assuming charge selection properly activated as part of IDA criteria. In some embodiments, this can offer an ability to align fragmentation species and can improve assignment and sequence coverage. Together, FIGS. 9B-C show % intensity v. m/z ion below 1000 Da that were achieved for the samples at each temperature.

### Example 4

The present example discloses thermally-induced dissociation of Tyr-Gly-Gly-Phe-Leu.

In this example, samples of a peptide Tyr-Gly-Gly-Phe-Leu, were ionized using electrospray ionization and fragmented using two different methods of fragmentation, a voltage induced fragmentation (DP) and a thermally-induced fragmentation (Temp). A mass spectrometry scan of the sample peptide was obtained.

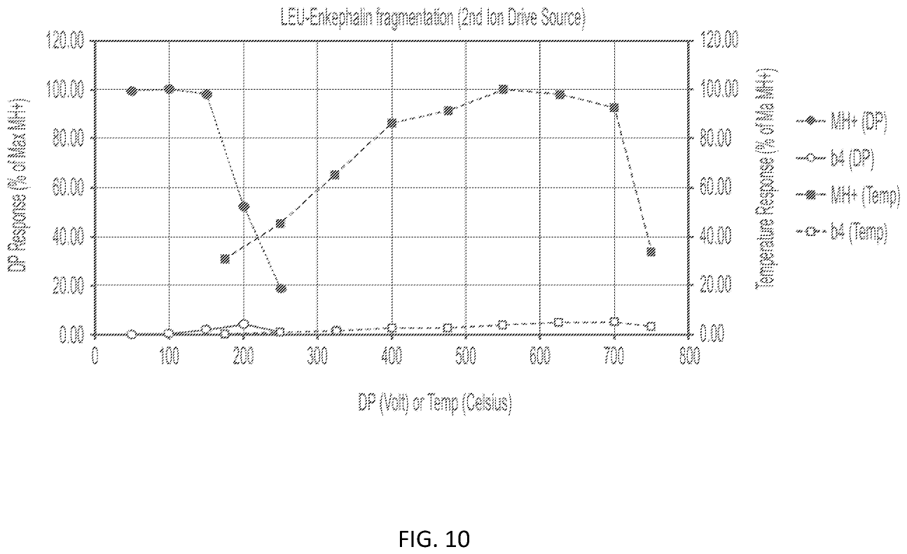

FIG. 10 shows that increasing the temperature of the sample ion, MH+ to an elevated temperature resulted in formation of a thermally dissociated b₄¹⁺ (also b₃¹⁺) fragment ion. As shown in both voltage induced and thermally-induced dissociation samples of FIG. 10, the singly charged peptide seemed to show little to no fragmentation, even at temperatures above 700° C. While not wishing to be bound to a particular theory, similar to voltage induced fragmentation, this suggests that thermally-induced dissociation is more applicable to multiply charged sample species.

### Example 5

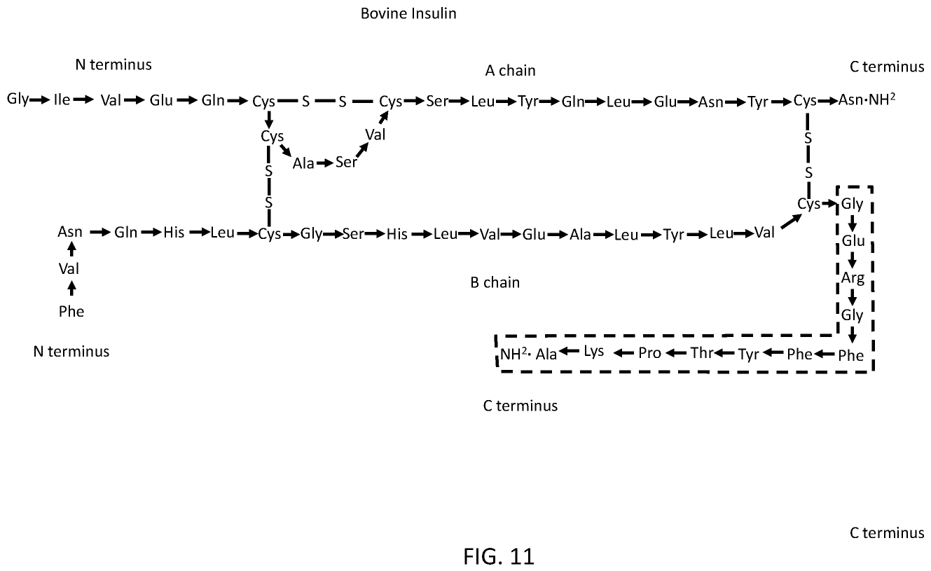

With reference to FIGS. 11-16, the present example discloses thermally-induced dissociation of analogs of insulin.

Three different analogues of insulin were investigated for the present example; bovine insulin, Arg-insulin and Novorapid.

FIG. 11 shows the sequence of bovine insulin.

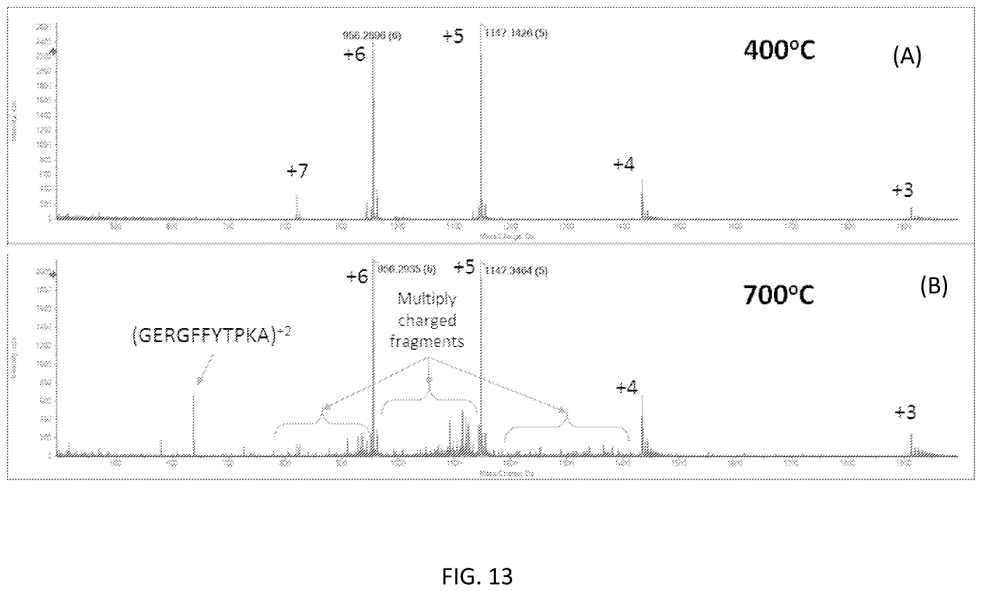

Samples of bovine insulin were ionized using electrospray ionization and the temperature of the samples of ions were elevated. FIG. 13 shows the fragmentation patterns of ionized bovine insulin samples following thermally-induced dissociation at 400° C. and 700° C. FIG. 13 at panel (A) shows the fragmentation pattern that was generated at 400° C. FIG. 13 at panel (B) shows the thermally-induced fragmentation pattern that was generated at 700° C. In this example, significant fragmentation was observed at the elevated temperature (panel B), with the majority of fragment species being multiply charged. Of note was the formation of fragments representative of the c-terminal end of the b-chain.

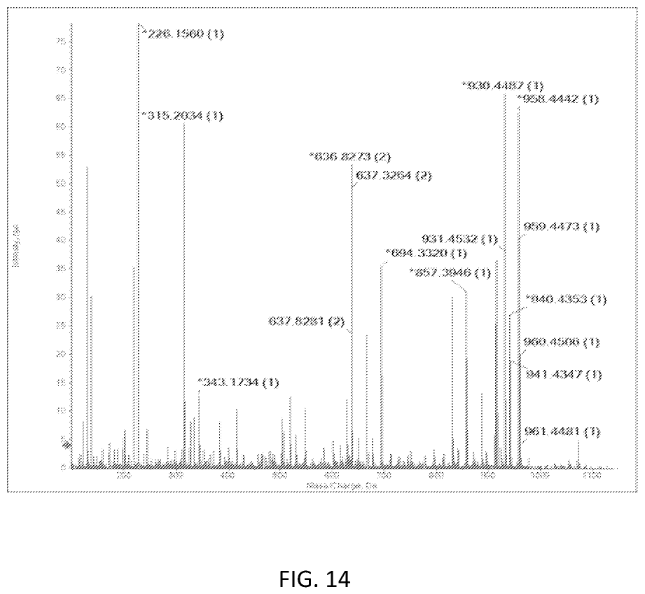

In another example, bovine insulin was ionized and the temperature of the ions was elevated in combination with collisionally-induced dissociation. FIG. 14 shows the fragmentation pattern of bovine insulin ionized using electrospray ionization, followed by thermally-induced dissociation at 700° C. and then collisionally-induced dissociation at 38 eV with CES=5 eV. As shown, the data exhibits formation of a mix of b- and y-ions, including (GERGFFYTPKA)⁺² from the C-terminus of the b-chain.

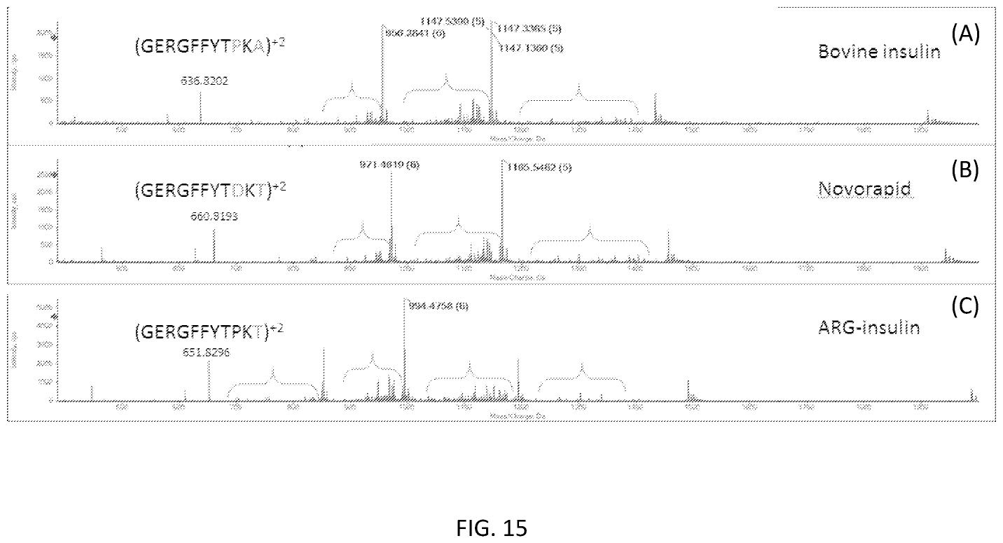

In another example, samples of each of bovine insulin; novorapid; and ARG-insulin were ionized using electrospray ionization and the temperature of the ions was elevated. FIG. 15 shows the fragmentation patterns of the thermally dissociated insulin analogs via thermally-induced dissociation at 700° C. FIG. 15 at panel (A) shows the fragmentation pattern of bovine insulin. FIG. 15 at panel (B) shows the fragmentation pattern of novorapid. FIG. 15 at panel (C) shows the fragmentation pattern of ARG-insulin. Significant fragmentation was generated from the bovine insulin and its analogs, with the majority of species being multiply charged. In these samples, significant fragmentation was observed with formation of fragments representative of the c-terminal end of the b-chain. The region of multiply charged fragment ions are highlighted with brackets.

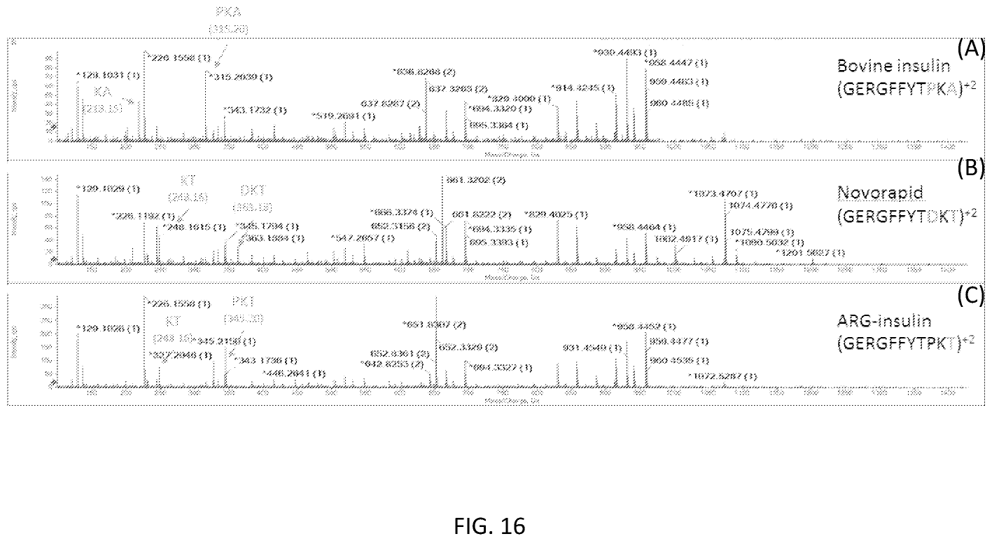

In another example, samples of each of bovine insulin; novorapid; and ARG-insulin were ionized using electrospray ionization and the temperature of the ions was elevated in combination with collisionally-induced dissociation. FIG. 16 shows the fragmentation pattern of the thermally-induced dissociation of these insulin analogs via thermally-induced dissociation at 700° C., followed by collisionally-induced dissociation at 38 eV with CES=5 eV resulting in the formation of the thermally dissociated ion having a general formula of (GERGFFYTxKx)²⁺. FIG. 16 at panel (A) shows fragmentation pattern of thermally dissociated bovine insulin, which was followed by collisionally-induced dissociation. FIG. 16 at panel (B) shows the fragmentation pattern of thermally dissociated novorapid, which was followed by collisionally-induced dissociation. FIG. 16 at panel (C) shows the fragmentation pattern of thermally dissociated ARG-insulin, which was followed by collisionally-induced dissociation.

### Example 6

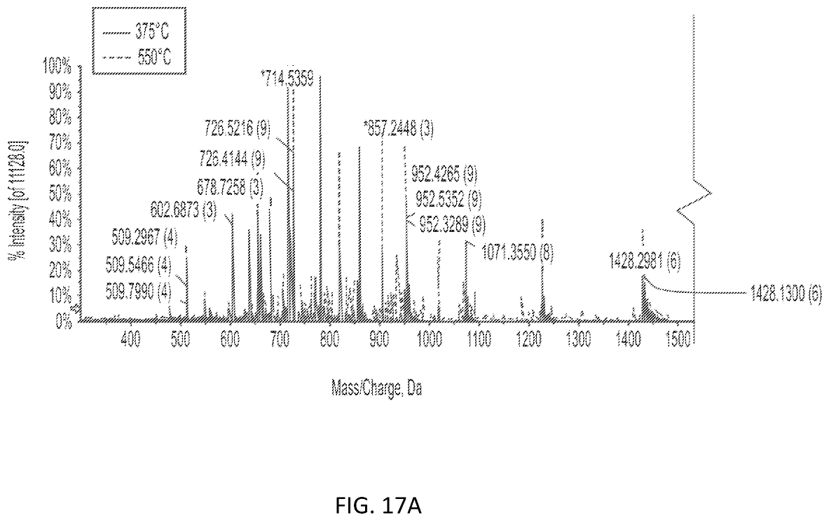

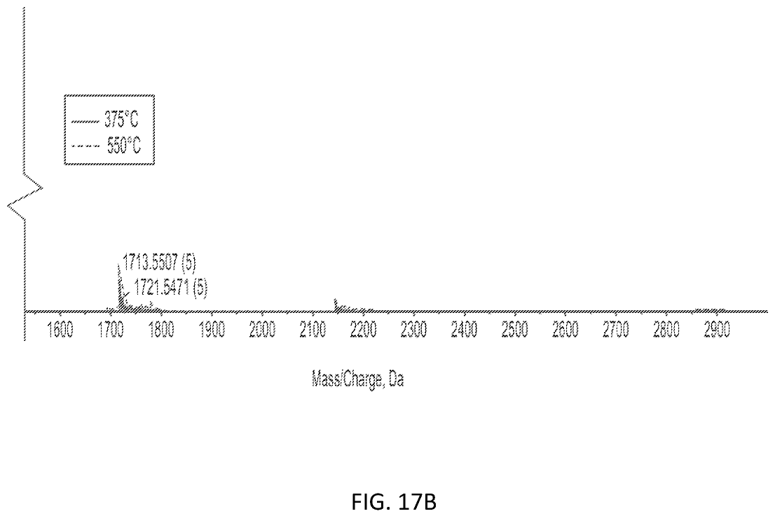

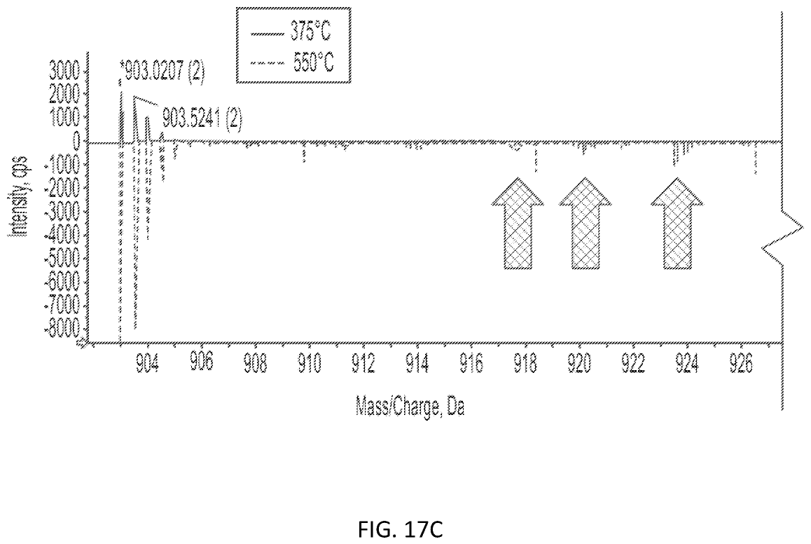

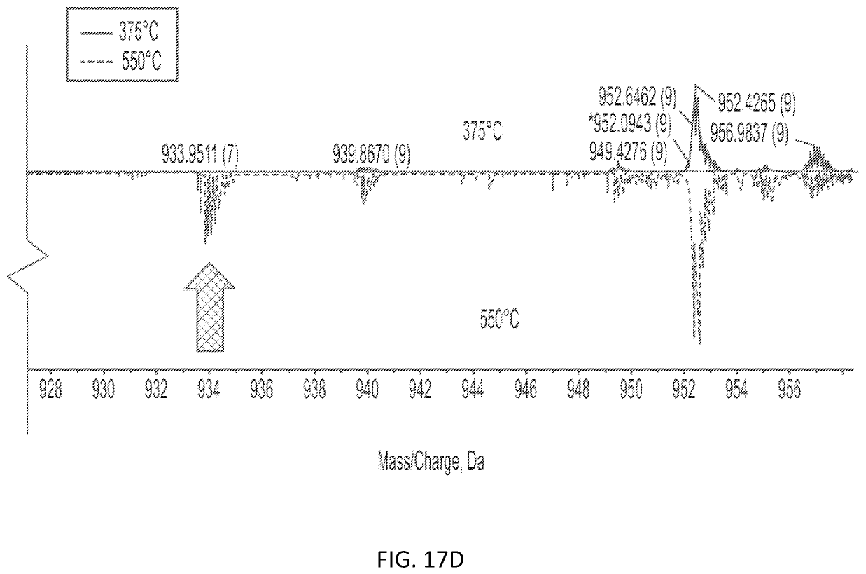

With reference to FIGS. 17A-D and 18A-D, the present example discloses thermally-induced dissociation of ubiquitin.

In this example, samples of ubiquitin were ionized and heated to an elevated temperature of 375° C. or 550° C. Together, FIGS. 17A-B show fragmentation patterns of ubiquitin obtained at 375° C. and 550° C. FIGS. 17A-B show the appearance of new species that were clearly generated at the elevated temperature via thermally-induced fragmentation. Together, FIGS. 17C-D shows the level of fragmentation of ubiquitin at 375° C. (top) and 550° C. (bottom). FIGS. 17C-D in particular show the appearance of additional fragment species because of the thermally-induced fragmentation process. Significant fragmentation was generated, with majority of species being multiply charged.

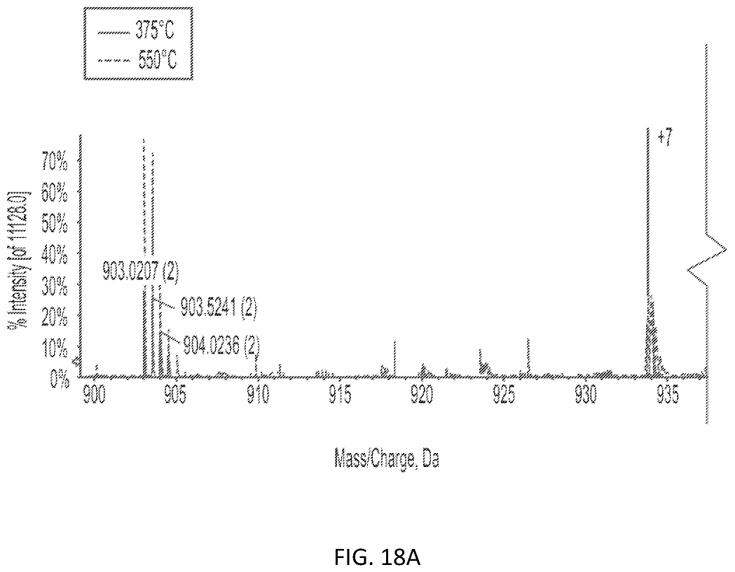

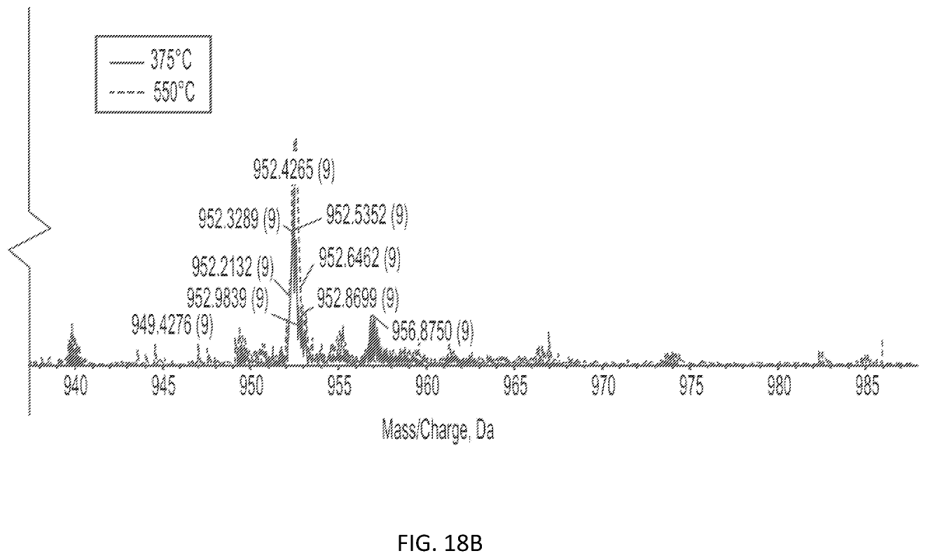

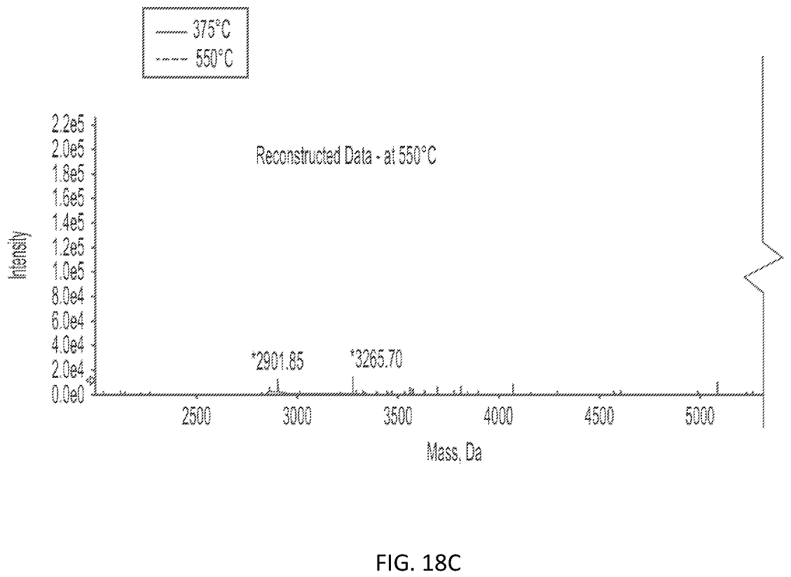

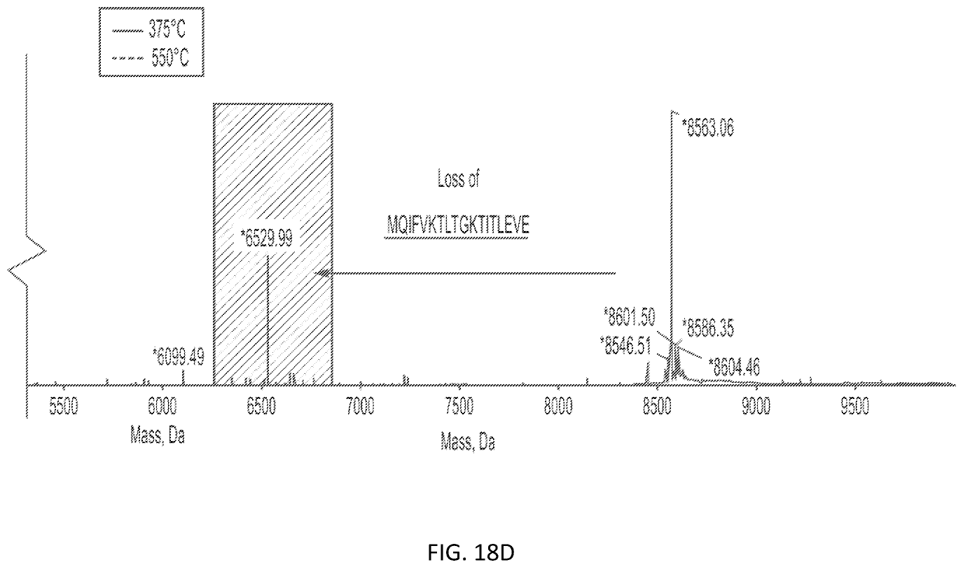

In another example, samples of ubiquitin were ionized using electrospray ionization. Samples were heated to temperatures of 375° C. or 550° C. Together, FIGS. 18A-B show the level of fragmentation observed in the m/z ion range of 900 to 1000 Da for samples acquired at both elevated temperatures. FIGS. 18A-B in particular show the appearance of the N-terminal sequence following thermally-induced dissociation when the temperature is increased from 375° C. to 550° C. Together, FIGS. 18C-D show the fragmentation pattern of ubiquitin obtained at 550° C. for the m/z ion range above 2500 Da. FIGS. 18C-D in particular show the appearance of a remainder of a chain of the ubiquitin sequence following thermally-induced dissociation when the temperature in the system is increased from 375° C. to 550° C. That is, as highlighted in FIG. 18D, the remainder of the chain of the ubiquitin sequence was generated from the thermally-induced dissociation of a major fragment that originated from loss of N-terminal sequence up to a proline.

### Example 7

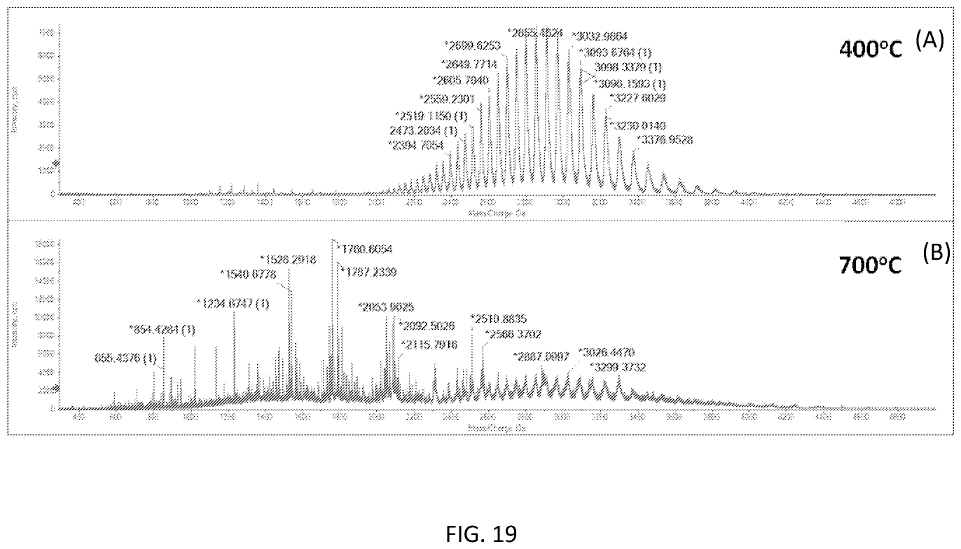

With reference to FIG. 19, the present example discloses thermally-induced dissociation of an intact monoclonal antibody.

In this example, samples of a monoclonal Ab were ionized using electrospray ionization and samples were heated to a temperature of 400° C. and 700° C. FIG. 19 at panel (A) shows the fragmentation pattern of the mAb at 400° C. FIG. 19 at panel (B) shows the fragmentation pattern of mAb at 700° C. With reference to FIG. 19 at panel (B), it is observed that there is significant thermally-induced fragmentation with a majority of species being multiply charged. Of note, the fragments formed and observed from the samples exposed to 700° C. were representative of the c-terminal end of the b-chain of the mAb.

### Example 8

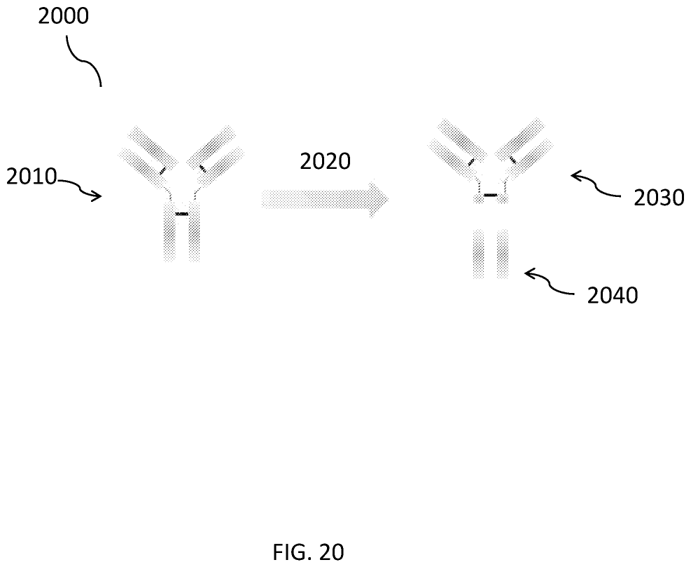

With reference to FIGS. 20-23, the present example discloses thermally-induced dissociation of a monoclonal antibody following treatment with an IdeS enzyme.

In this example, samples of a monoclonal Ab were first digested with IdeS enzyme and then chemically separated. The resultant sample species were ionized using electrospray ionization and elevated to a temperature of 200° C. and 550° C.

FIG. 20 shows a general reaction 2000 of a monoclonal antibody 2010 with an IdeS protease enzyme treatment 2020. As shown in FIG. 20, the intact molecular antibody 2010 has a molecular weight of about 150 kDa. After treatment with IdeS, the molecular antibody 2010 is cleaved at the hinge to form two major species, F(ab′)₂ 2030 and scFc (2×) [that is, there are 2 of them] 2040. The F(ab′)₂ 2030 has a molecular weight of about 100 kDa and the scFc (2×) 2040 has a molecular weight of about 25 kDa.

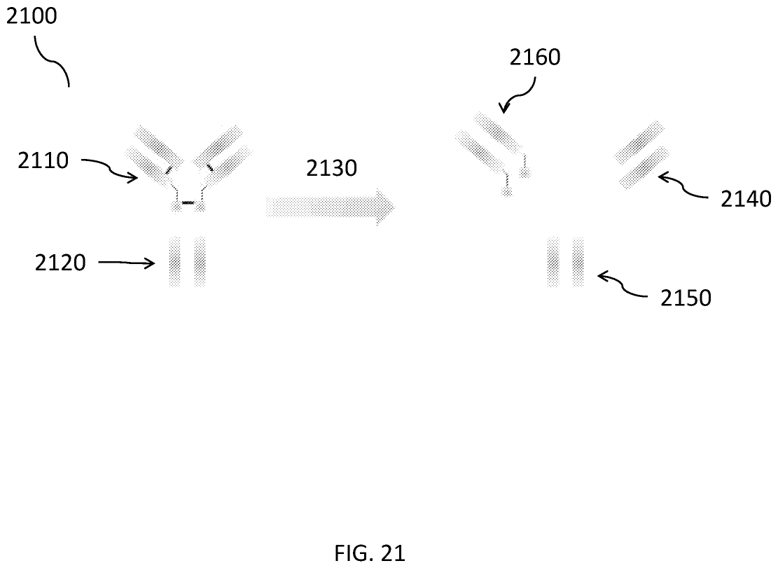

FIG. 21 shows a general reaction 2100 of the two major species, F(ab′)₂ 2110 and scFc (2×) 2120 in a Disulfide Reduction (DTT) 2130. After the reduction, the two major species were reduced via a chemical reduction to a light chain 2140, an scFc (2×) 2150, and an Fd′ (2×) 2160. Each product component of the reduction reaction 2130 has a molecular weight of about 25 kDa. The treatment with IdeS generates cleavages at the hinge. The two major species, scFc and F(ab′)₂ were separated. Both of the two major species, scFc and F(ab′)₂ can be fragmented by increasing the temperature.

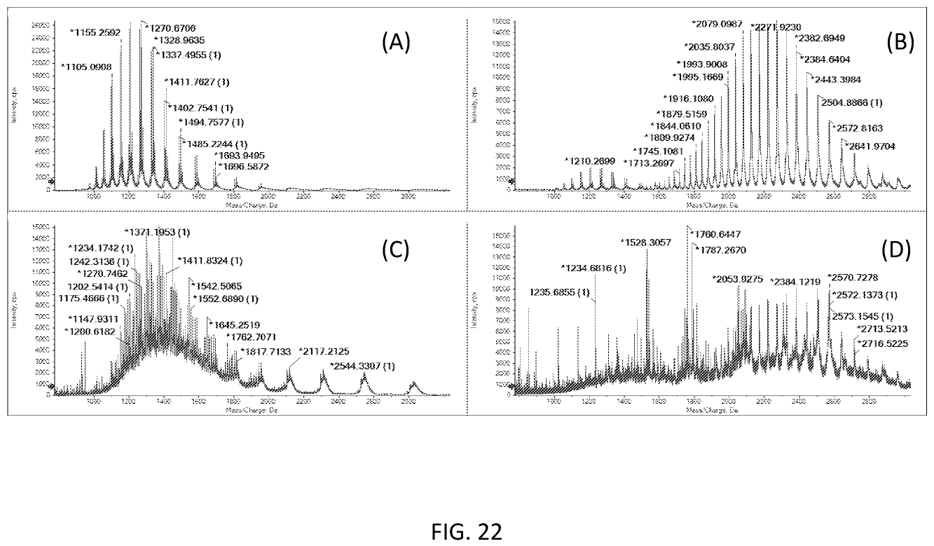

FIG. 22 at panel (A) shows the fragmentation pattern of the scFc at 200° C. FIG. 22 at panel (C) shows the fragmentation pattern of the scFc at 550° C. FIG. 22 at panel (B) shows a fragmentation pattern of the F(ab′)₂ at 200° C. FIG. 22 at panel (D) shows a fragmentation pattern of the F(ab′)₂ at 550° C. The scFc species seems to generate sequential losses of the glycan unit.

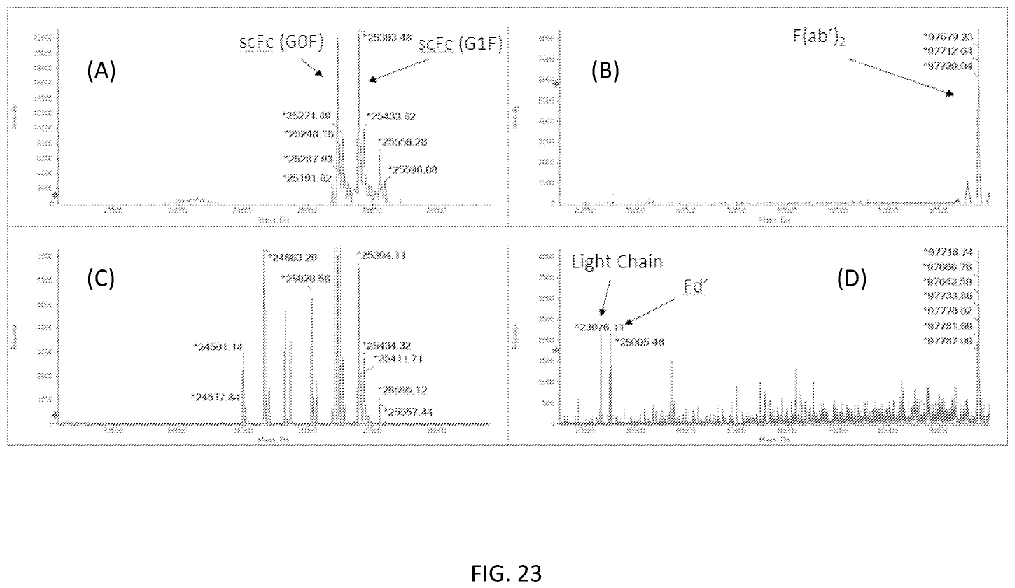

FIG. 23 at panel (A) shows a high mass range fragmentation pattern of the scFc at 200° C. FIG. 23 at panel (C) shows a high mass range fragmentation pattern of the scFc at 550° C. The scFc species seems to generate sequential losses of the glycan unit. FIG. 23 at panel (B) shows a high mass range fragmentation pattern of the F(ab′)₂ at 200° C. FIG. 23 at panel (D) shows a high mass range fragmentation pattern of the F(ab′)₂ at 550° C. FIG. 23 at panel (D) shows the F(ab′)₂ produces lower molecular species that seem to correspond to the light chain species (arrow). While not wishing to be bound to a particular theory, it is believed that the light chain generates what appears to be sequential losses of the glycan. Generating the light chain and Fd′ fragments at the source opens up possibility to further improve sequence coverage information with electron capture dissociation, without additional sample preparation steps.

### Example 9

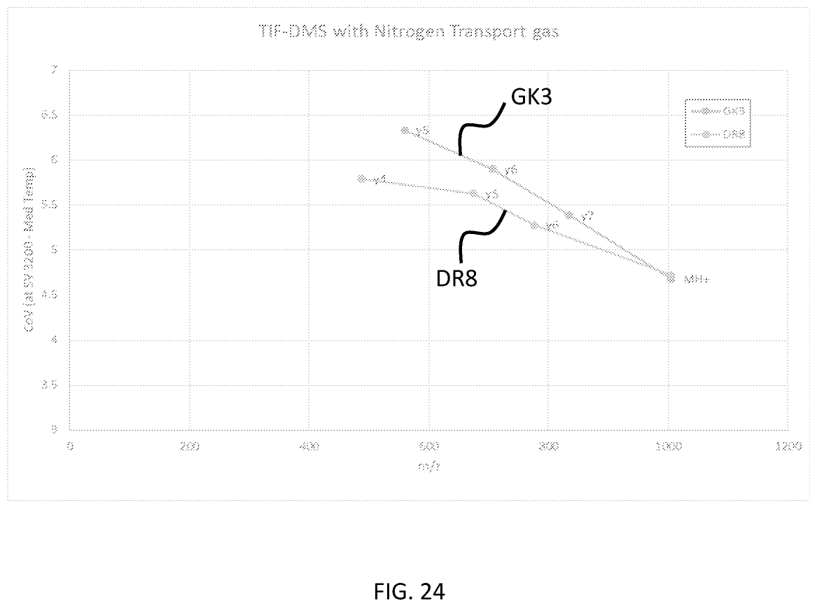

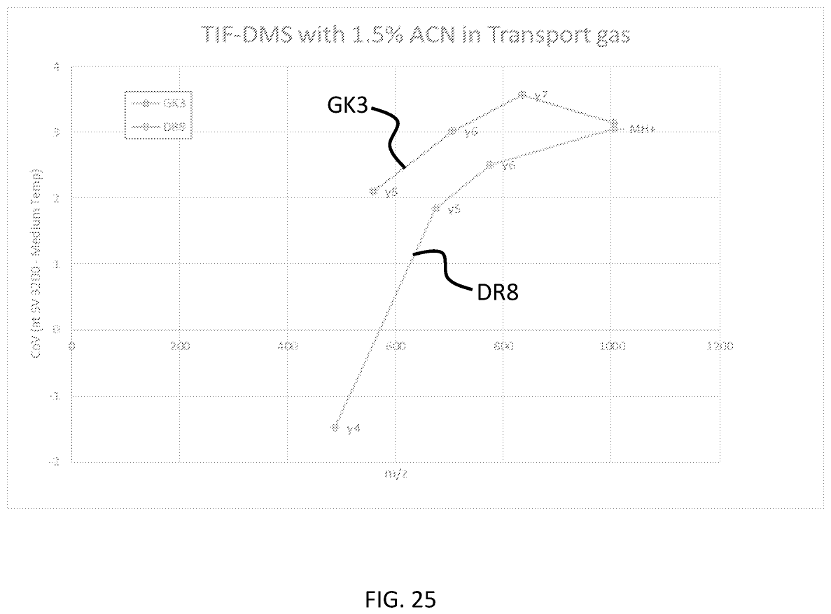

With reference to FIGS. 24 and 25, the present example discloses thermally-induced dissociation of a peptide in combination with differential mobility spectrometry.

In this example, multiple peptide samples were ionized using electrospray ionization, raised to an elevated temperature, and separated by differential mobility spectrometry. Specifically, in this example, a thermally dissociated GK3 peptide (GLEFSDPLK) ion was monitored for the MH+ (y9), (y7), (y6) and (y5). Additionally, in this example, a thermally dissociated DR8 peptide, (DDTWVTLR) ion was monitored for the MH+ (y8), (y6), (y5) and (y4).

FIG. 24 shows thermally-induced dissociation with differential mobility spectrometry and having nitrogen (N₂) as transport gas with a separation voltage of 3200V. With nitrogen as the transport gas, the resultant linear trend for CoV values was more likely driven by decrease in cross section. FIG. 25 shows thermally-induced dissociation with differential mobility spectrometry and having 1.5% acetonitrile (ACN) present in the transport gas with a separation voltage of 3200V. ACN is generally known to cluster with peptides. While not wishing to be bound by a particular theory, it is believed that ACN in the gas phase will form stable adducts with peptides. Thus, adduct formation and therefore fragmentation pattern can be dependent on peptide sequence structure and its ability to form intra-molecular hydrogen bonds to stabilize that structure.

The present disclosure is not limited to the embodiments described and exemplified above but is capable of variation and modification within the scope of the appended claims. The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

Various publications, including patents, published applications, technical articles and scholarly articles are cited throughout the specification. Each of these cited publications is incorporated by reference herein, in its entirety and for all purposes.

### Other Embodiments and Equivalents

While the present disclosure has explicitly discussed certain particular embodiments and examples of the present disclosure, those skilled in the art will appreciate that the disclosure is not intended to be limited to such embodiments or examples. On the contrary, the present disclosure encompasses various alternatives, modifications, and equivalents of such particular embodiments and/or example, as will be appreciated by those of skill in the art.

Accordingly, for example, methods and diagrams of should not be read as limited to a particular described order or arrangement of steps or elements unless explicitly stated or clearly required from context (e.g., otherwise inoperable). Furthermore, different features of particular elements that may be exemplified in different embodiments may be combined with one another in some embodiments.

1. A method of fragmenting ions in a mass spectrometry system, comprising steps of:
using an ion source to ionize a sample so as to produce a plurality of ions, wherein an ionization/fragmentation region is associated with the ion source;
increasing a temperature of the plurality of ions to an elevated temperature, wherein the elevated temperature promotes thermally-induced dissociation of at least a portion of the plurality of ions; and
transmitting the thermally dissociated ions to and through an inlet of a vacuum chamber containing a downstream mass analyzer.

2. The method of claim 1, the step of transmitting the thermally dissociated ions to the inlet comprises transmitting the ions along a path such that at least 50% of the ions do not encounter a surface prior to reaching the inlet.

3. The method of claim 1, wherein the transmitted thermally dissociated ions are substantially free of undergoing diffusional losses, and optionally, wherein the thermally dissociated ions are substantially free of formation of cation adducts.

4. (canceled)

5. The method of claim 1, wherein the step of increasing the temperature comprises a step of exposing the plurality of ions to a source of electromagnetic radiation, and optionally, wherein the step of exposing comprises substantially co-axially radiating the plurality of ions.

6. (canceled)

7. The method of claim 1, wherein the step of increasing the temperature is performed such that at least 50% of ion fragmentation due to temperature increase occurs within the ionization/fragmentation region, and optionally, wherein the source of electromagnetic radiation comprises a thermal energy source.

8. (canceled)

9. The method of claim 1, wherein the elevated temperature of the plurality of ions is at least about 550° C., and optionally, wherein the elevated temperature of the plurality of ions is about 550° C. to about 850° C.

10. (canceled)

11. The method of claim 1, wherein the elevated temperature causes the thermal fragmentation at a fragmentation efficiency of at least about 70%, and optionally, wherein the elevated temperature causes the thermal fragmentation at a fragmentation efficiency of at least about 85%.

12. (canceled)

13. The method of claim 1, wherein the ion source is selected from the group consisting of: an atmospheric pressure ion source; an atmospheric pressure chemical ion source;
an electrospray ion source; a desorption ionization source; a beam ionization source; and a photoionization source.

14. The method of claim 1, wherein the ionization/fragmentation region extends a distance of about 2-3 mm from an exit of the ion source, and optionally, wherein the ion source comprises an electrospray source and the ionization/fragmentation region extends a distance of about 2-3 mm from a nozzle of the electrospray of the ion source.

15. (canceled)

16. The method of claim 1, wherein the ionization/fragmentation region extends a distance of up to about 7.5 mm from an exit of the ion source.

17. The method of claim 1, wherein the sample comprises any peptide, and optionally, wherein the sample has a molecular weight of at least about 40 kDa.

18. (canceled)

19. The method of claim 1, wherein the plurality of ions comprises at least some multiply charged ions.

20. The method of claim 1, further comprising a step of fragmenting at least a portion of the thermally dissociated ions via electron capture dissociation.

21. A mass spectrometry system, comprising:
an ion source to ionize a sample for generating a plurality of ions;
an ionization/fragmentation region associated with the ion source; and
a heat source configured for increasing the temperature of the plurality of ions to an elevated temperature,
wherein the elevated temperature promotes thermally-induced dissociation of at least a portion of the plurality of ions within the ionization/fragmentation region.

22. The mass spectrometry system of claim 21, wherein the heat source comprises a thermal energy source, and optionally, wherein radiation from the thermal energy source is emitted substantially co-axial from the ion source.

23. The mass spectrometry system of claim 21, further comprising an inlet disposed between the ion source and a vacuum chamber containing one or more downstream components of the mass spectrometry system, and optionally, wherein the ionization/fragmentation region and the inlet are positioned relative to one another such that a majority of the thermally dissociated ions reach the inlet without encountering a surface.

24. (canceled)

25. The mass spectrometry system of claim 21, wherein the transmitted thermally dissociated ions exhibit a fragmentation pattern.

26. The mass spectrometry system of claim 23, further comprising a differential ion mobility spectrometry device disposed between the ion source and the inlet.

27. The mass spectrometry system of claim 23, wherein the position of the ionization/fragmentation region and the inlet forms a substantially surface-free path.

28. The mass spectrometry system of claim 21, wherein the ionization/fragmentation region extends a distance of about 2-3 mm from an exit of the ion source, and optionally, wherein the ion source comprises an electrospray source and the ionization/fragmentation region extends a distance of about 2-3 mm from a nozzle of the electrospray of the ion source.

29. (canceled)

30. The mass spectrometry system of claim 21, wherein the ionization/fragmentation region extends a distance of up to about 7.5 mm from an exit of the ion source, and optionally, wherein the ion source comprises an electrospray source and the ionization/fragmentation region extends a distance of up to about 7.5 mm from a nozzle of the electrospray of the ion source.

31. (canceled)

32. (canceled)

33. A method of thermally inducing fragmentation of ions in a mass spectrometry system, comprising the steps of:
providing the mass spectrometry system of claim 21;
introducing a sample to the ion source;
ionizing the introduced sample to form a plurality of ions;
increasing the temperature of a plurality of ions within the ionization/fragmentation region, wherein the increased temperature promotes thermally-induced dissociation of the plurality of ions; and
transmitting at least a portion of the dissociated ions from the ion source region downstream in the mass spectrometry system, wherein the transmitted thermally dissociated ions exhibit a fragmentation pattern, and optionally, wherein the fragmentation pattern is a selectively enhanced fragmentation pattern exhibiting molecular weights of less than about 50 kDa.

34. (canceled)
